(19) United States
(12) Patent Application Publication
(10) Pub. No.: US 2018/0023502 A1
(43) Pub. Date: Jan. 25, 2018

(54) INJECTION SYSTEM FOR AN INTERNAL COMBUSTION ENGINE AND INTERNAL COMBUSTION ENGINE HAVING SUCH AN INJECTION SYSTEM

(71) Applicant: MTU FRIEDRICHSHAFEN GMBH, Friedrichshafen (DE)

(72) Inventor: Armin DÖLKER, Friedrichshafen (DE)

(21) Appl. No.: 15/546,061

(22) PCT Filed: Mar. 16, 2016
(86) PCT No.: PCT/EP2016/000468

§ 371 Date: Jul. 25, 2017

(30) Foreign Application Priority Data
May 21, 2015 (DE) 10 2015 209 377.8

(51) Int. Cl. F02D 41/38; F02M 63/00; F02D 41/22

(52) U.S. Cl. CPC F02D 41/3845; F02D 41/22; F02M 63/0052; F02D 2041/224

(57) ABSTRACT

An injection system for an internal combustion engine including at least one injector and a high-pressure accumulator, which has a fluid connection to the at least one injector on the one side and has a fluid connection to a fuel reservoir via a high-pressure pump on the other side, wherein a suction throttle is associated with the high-pressure pump as a first pressure-setting element. At least two pressure control valves are provided, via which the high-pressure accumulator can be brought into fluid connection with the fuel reservoir.

The invention relates to an injection system for an internal combustion engine and to an internal combustion engine having an injection system of said type.

The German patent application DE 10 2014 213 648.2, which does not constitute a prior publication, discloses a method for operating an internal combustion engine having an injection system, in which method a pressure regulating valve is, in a first operation type of a protective operating mode, actuated in order to regulate a high pressure in a high-pressure accumulator, wherein the pressure regulating valve is, in a second operation type of the protective operating mode, permanently opened in order to prevent an inadmissibly high pressure increase in the high-pressure accumulator. For relatively small internal combustion engines with low rated power and/or with a relatively small number of combustion chambers, this embodiment can be realized functionally, easily and inexpensively. It is however a disadvantage that the embodiment can be scaled only to a limited extent or with considerable outlay and high costs. Specifically, relatively large internal combustion engines with relatively high rated power and/or a relatively large number of combustion chambers require, in the event of a fault, a means for allowing larger quantities of fuel to be discharged than relatively small internal combustion engines with relatively low rated power and/or a relatively small number of combustion chambers. Therefore, if it is sought in the case of a relatively large internal combustion engine to establish a corresponding regulation and safety function, there is a need for a pressure regulating valve which is designed for discharging correspondingly relatively large quantities of fuel. Such pressure regulating valves are however custom-made items which can be manufactured only in small batches, such that they are relatively expensive. Furthermore, different pressure regulating valves are required for internal combustion engines with different levels of rated power and/or different numbers of combustion chambers, which would also increase logistical costs.

The invention is based on the object of providing an injection system for an internal combustion engine and an internal combustion engine having an injection system of said type, wherein the stated disadvantages do not arise.

The object is achieved through the creation of the subjects of the independent claims. Advantageous embodiments emerge from the subclaims.

The object is achieved in particular in that an injection system for an internal combustion engine is created which has at least one injector and at least one high-pressure accumulator, which is fluidically connected at one side to the at least one injector and at the other side via a high-pressure pump to a fuel reservoir, wherein the high-pressure pump is assigned a suction throttle as pressure setting element. The injection system is distinguished by the fact that at least two pressure regulating valves are provided by means of which the high-pressure accumulator can be fluidically connected, preferably is fluidically connected, to the fuel reservoir. By virtue of the fact that the injection system has at least two pressure regulating valves, protective and/or regulating functions achieved by means of the pressure regulating valves can be implemented by more than one pressure regulating valve, such that an increased volume flow can be discharged from the high-pressure accumulator without the need for scaling of the individual pressure regulating valves used. Rather, scaling can be implemented by means of the number of pressure regulating valves used. The individual pressure regulating valves can thus be installed as inexpensive mass-produced parts, which saves logistical costs, and wherein the individual pressure regulating valves are themselves inexpensive.

There is then also no need to stock different pressure regulating valves for different internal combustion engines, it rather being possible for relatively large internal combustion engines to be equipped with a greater number of pressure regulating valves than relatively small internal combustion engines.

The suction throttle is preferably arranged on a low-pressure side of the high-pressure pump, and is thus a low-pressure-side suction throttle which is assigned to the high-pressure pump. The suction throttle is accordingly arranged in particular upstream of the high-pressure pump. Preferably, upstream of the high-pressure pump, there is also arranged a low-pressure pump by means of which fuel can be delivered from the fuel reservoir to the high-pressure pump. The suction throttle is in this case preferably arranged fluidically between the low-pressure pump and the high-pressure pump. It is possible for the suction throttle to be formed integrally with the high-pressure pump.

The at least two pressure regulating valves are preferably arranged fluidically in parallel with respect to one another, wherein they both—in a parallel connection configuration—connect the high-pressure accumulator to the fuel reservoir. Thus, if two identical pressure regulating valves—in particular with identical rated throughflow—are used, a doubled volume flow can be discharged from the high-pressure accumulator into the fuel reservoir via the pressure regulating valves in relation to an embodiment in which only one pressure regulating valve is provided.

The injection system is preferably free from a mechanical pressure relief valve, that is to say has no mechanical pressure relief valve. A mechanical pressure relief valve can be dispensed with because a corresponding protective function can—as will be discussed below—be provided by means of the at least two pressure regulating valves. The costs otherwise associated with a mechanical pressure relief valve can thus be saved.

The injection system preferably has a high-pressure sensor by means of which a high pressure in the high-pressure accumulator can be detected. The high-pressure sensor is preferably arranged on the high-pressure accumulator. It is however also possible to measure the high pressure in the injection system at some other location, wherein it is possible if necessary to infer the pressure in the high-pressure accumulator from the high pressure measured at the other location, or wherein the high pressure measured at the other location can be used for the control of the injection system.

The high-pressure accumulator is preferably in the form of a common high-pressure accumulator to which a multiplicity of injectors is fluidically connected. A high-pressure accumulator of said type is also referred to as a rail, wherein the injection system is preferably in the form of a common-rail injection system.

An exemplary embodiment of the injection system is preferred which is distinguished by a control unit which is operatively connected to the suction throttle and to the at least two pressure regulating valves and preferably to the at least one injector. The injection system, in particular the control unit, is in this case designed to, in a normal operating mode, regulate a high pressure in the high-pressure accumulator by actuating the suction throttle as pressure setting element. It is preferably the case that, in the normal operating mode, at least one first pressure regulating valve of the at least two pressure regulating valves is actuated in order to generate a high-pressure disturbance variable.

The injection system, in particular the control unit, is furthermore designed to, in a first operation type of a protective operating mode, regulate the high pressure in the high-pressure accumulator by actuating at least one first pressure regulating valve of the at least two pressure regulating valves as pressure setting element. The injection system, in particular the control unit, is furthermore designed to, in a second operation type of the protective operating mode, actuate at least one second pressure regulating valve of the at least two pressure regulating valves, wherein the at least one second pressure regulating valve differs from the at least one first pressure regulating valve, in addition to the at least one first pressure regulating valve as pressure setting element in order to regulate the high pressure in the high-pressure accumulator.

In the normal operating mode, therefore, conventional regulation of the high pressure by means of the suction throttle is provided, wherein it is preferably the case that, at the same time, by means of at least one first pressure regulating valve, a high-pressure disturbance variable is generated by virtue of fuel being discharged from the high-pressure accumulator via the at least one first pressure regulating valve into the fuel reservoir. Such a regulating strategy is known for example from the German patent DE 10 2009 031 529 B3. The high-pressure disturbance variable in effect replicates a constant leakage, whereby the stability of the high-pressure regulation in the low-load range is increased.

In the first operation type of the protective operating mode, the high pressure in the high-pressure accumulator is, by contrast, regulated by means of at least one first pressure regulating valve. In this way, it can be provided that regulation of the high pressure remains possible, specifically by means of the at least one first pressure regulating valve, even in the event of a failure of regulation by means of the suction throttle—in particular in the event of a failure of the suction throttle itself as pressure setting element, for example owing to a cable breakage, a failure to remember to connect the suction throttle plug connector, jamming of or an accumulation of dirt on the suction throttle, or some other fault or defect. Firstly, it is thus possible for the injection system to be protected against an inadmissibly high high pressure, and secondly, a periodic fluctuation of the high pressure is prevented. Said high pressure is rather regulated by means of the actuation of the at least one first pressure regulating valve to a setpoint value, such that no impairment of emissions characteristics of the internal combustion engine occurs.

Operating situations can however arise in which the at least one first pressure regulating valve is no longer sufficient for functioning high-pressure regulation, such that the high pressure increases further despite actuation of the at least one first pressure regulating valve. Then, in the second operation type of the protective operating mode, it is possible to activate the at least one second pressure regulating valve such that, now, the at least one first pressure regulating valve and the at least one second pressure regulating valve are actuated jointly as pressure setting elements for the pressure regulation of the high pressure. In this way, in particular, relatively large discharge quantities are achieved, such that efficient and reliable pressure regulation is possible even in the case of a relatively high discharge demand.

In the normal operating mode, the high pressure is regulated preferably by actuation of the suction throttle as pressure setting element in a first high-pressure regulating loop. In the first operation type of the protective operating mode, the high pressure is regulated preferably by actuation of the at least one first pressure regulating valve in a second high-pressure regulating loop which differs from the first high-pressure regulating loop. This permits a separation of the two regulating loops and the targeted coordination thereof with firstly the actuation of the suction throttle and secondly the at least one first pressure regulating valve.

If the at least one first pressure regulating valve and the at least one second pressure regulating valve differ—in particular in terms of their rated throughflows—it is possible for the at least one second pressure regulating valve to be actuated, in the second operation type of the protective operating mode, by means of a third high-pressure regulating loop. Use is however preferably made of first and second pressure regulating valves which correspond, at least with regard to their characteristic values, in particular with regard to a rated throughflow, wherein it is then preferably provided that, in the second operation type of the protective operating mode, the at least one first pressure regulating valve and the at least one second pressure regulating valve are actuated by the same, second high-pressure regulating loop. Here, it is however preferable for separate current regulators to be provided for the energization of the various pressure regulating valves.

In a preferred exemplary embodiment of the injection system, it is provided that, in the normal operating mode, only one of the pressure regulating valves, in particular exactly one and only one first pressure regulating valve, is actuated in order to generate the high-pressure disturbance variable. The at least one further pressure regulating valve is then preferably closed or is actuated into a closed state. It may however also be provided that, in the normal operating mode, more than one first pressure regulating valve is actuated in order to generate the high-pressure disturbance variable, wherein it is possible in particular for a subset of the total number of pressure regulating valves provided to be actuated in order to generate a high-pressure disturbance variable. Finally, it is also possible for all of the pressure regulating valves provided to be actuated in order to generate a high-pressure disturbance variable. Here, the number of pressure regulating valves actually actuated in order to generate the high-pressure disturbance variable may in particular be selected in a pressure-dependent manner.

In the first operation type of the protective operating mode, it is preferable for only one and exactly one first pressure regulating valve to be actuated as pressure setting element. Other pressure regulating valves are preferably closed or are actuated into a closed state. It is alternatively possible for a subset of the pressure regulating valves provided, in particular more than one first pressure regulating valve, to be actuated as first pressure regulating valves and pressure setting elements. It is however preferable for at least one pressure regulating valve to remain in the first operation type, which as a second pressure regulating valve is not actuated as pressure setting element but rather is closed or is actuated into a closed state.

Said at least one remaining second pressure regulating valve is activated, that is to say actuated as further pressure setting element, in the second operation type of the protective operating mode. Here, it is possible for exactly one second pressure regulating valve to be activated in the second operation type. It is alternatively possible for a subset, in particular more than one second pressure regulating valve, to be activated as pressure setting elements. It is preferable for all remaining pressure regulating valves which are not already actuated as first pressure regulating valves and pressure setting elements in the first operation type to additionally be actuated as pressure setting elements and second pressure regulating valves in the second operation type. Here, it is possible for a number of activated, second pressure regulating valves to be selected in a pressure-dependent manner. In particular, a number of second pressure regulating valves is activated in a pressure-dependent manner.

An exemplary embodiment of the injection system is preferred which is characterized in that, for the at least one pressure regulating valve in the normal operating mode, a normal function is set in which the at least one first pressure regulating valve is actuated in a manner dependent on a setpoint volume flow. Here, in the normal operating mode, the normal function provides for the first pressure regulating valve an operation type in which said first pressure regulating valve generates a high-pressure disturbance variable by discharging fuel from the high-pressure accumulator into the fuel reservoir.

It is preferably the case that the normal function is set for the at least one first pressure regulating valve in the first operation type and in the second operation type of the protective operating mode, too, such that the pressure regulating valve is actuated in a manner dependent on a setpoint volume flow. In the second operation type of the protective operating mode, this preferably also applies to the at least one second pressure regulating valve. The normal operating mode, on the one hand, and the first and second operation types of the protective operating mode, on the other hand, differ in this case preferably in terms of the manner in which the setpoint volume flow for the actuation of the pressure regulating valves is calculated:

In the normal operating mode, the setpoint volume flow is preferably calculated from a steady-state setpoint volume flow and a dynamic setpoint volume flow. The steady-state setpoint volume flow is in turn preferably calculated in a manner dependent on a setpoint injection quantity and an engine speed of the internal combustion engine by means of a setpoint volume flow characteristic map. In the case of a torque-oriented structure, it is possible here for a setpoint torque or a setpoint load demand to also be used instead of the setpoint injection quantity. By means of the steady-state setpoint volume flow, a constant leakage is replicated by virtue of the fuel being discharged only in a low-load range and in small quantities. Here, it is advantageous that no significant increase of the fuel temperature and also no significant reduction in the efficiency of the internal combustion engine occur. Through the replication of a constant leakage for the injection system by means of at least one pressure regulating valve, the stability of the high-pressure regulating loop in the low-load range is increased, which is evident for example from the fact that the high pressure remains approximately constant during overrun operation. The dynamic setpoint volume flow is calculated by means of a dynamic correction in a manner dependent on a setpoint high pressure and the actual high pressure, or a dynamic rail pressure defined in more detail below, or in a manner dependent on the regulating deviation derived therefrom. If the regulating deviation is negative, for example in the event of a load dump of the internal combustion engine, the steady-state setpoint volume flow is corrected by means of the dynamic setpoint volume flow. Otherwise, that is to say in particular in the event of a positive regulating deviation, no change in the steady-state setpoint volume flow is performed. By means of the dynamic setpoint volume flow, an increase of the high pressure is counteracted, with the advantage that the settling time of the system can be yet further improved.

This approach is described in detail in the German patents DE 10 2009 031 529 B3 and in particular DE 10 2009 031 527 B3. The at least one first pressure regulating valve is thus, in the normal operating mode, actuated by means of the setpoint volume flow such that, by means of the replication of a constant leakage, said pressure regulating valve increases the stability of the high-pressure regulating loop and, by means of the correction by means of the dynamic setpoint volume flow, improves the settling time of the injection system.

In the first and in the second operation type of the protective operating mode, it is the case, by contrast, that the setpoint volume flow is preferably calculated in the second high-pressure regulating loop—in particular by a pressure regulating valve pressure regulator. In this case, the setpoint volume flow constitutes a control variable of the second high-pressure regulating loop, and serves for the direct regulation of the high pressure.

It is preferable for an actuation mechanism for the pressure regulating valves to be provided, which actuation mechanism has the setpoint volume flow as input variable. It is then preferably the case that, by means of a—possibly virtual—switch, upon the switchover from the normal operating mode to the first operation type and/or to the second operation type of the protective operating mode, a switchover is performed from the calculation of the setpoint volume flow as a resultant volume flow made up of the steady-state and the dynamic setpoint volume flows to the calculation in the second high-pressure regulating loop. Here, it is preferably the case that the integral component of the pressure regulating valve pressure regulator of the second high-pressure regulating loop is, upon the switchover, initialized with the most recently calculated resultant setpoint volume flow before the switchover, such that a disturbance-free, smooth switchover is realized.

Also preferred is an exemplary embodiment of the injection system which is characterized in that the injection system, in particular the control unit, is designed to, in a third operation type of the protective operating mode, permanently open the at least one first pressure regulating valve and the at least one second pressure regulating valve. This means in particular that a large, preferably maximum fuel volume flow is constantly discharged from the high-pressure accumulator into the fuel reservoir by means of the pressure regulating valves. That is to say, in particular, that in the protective operating mode, the pressure regulating valves are actuated in the direction of opening to a maximum extent. It is particularly preferable for the pressure regulating valves to be opened to a maximum extent in the third operation type of the protective operating mode. Depending on whether the pressure regulating valves are designed to be open when deenergized or closed when deenergized, it is preferable here for a high, preferably maximum actuation current to be selected, or a low actuation current or even no actuation current. The fuel volume flow that actually passes through the pressure regulating valves here is dependent on the high pressure in the high-pressure accumulator, wherein the expression “maximum fuel volume flow” refers to a situation in which the pressure regulating valves are opened to the maximum extent. In this embodiment, an inadmissibly high high pressure in the high-pressure accumulator is rapidly and reliably dissipated not only temporarily but permanently, such that the injection system is protected in an effective and reliable manner. This functionality makes it possible to dispense with a mechanical pressure relief valve, such that structural space and costs can be saved.

The expression “permanently” means in particular that, in the third operation type, the pressure regulating valves are actuated no longer with an actuation signal that varies over time but rather continuously with a constant actuation signal which results in a predetermined opening of the pressure regulating valves, preferably an opening to a maximum extent. Here, it may be the case that the actuation signal is selected to be constant at zero if the pressure regulating valves are designed to be open when deenergized.

It is preferable if, in the third operation type of the protective operating mode, all of the pressure regulating valves are opened permanently and in particular to a maximum extent. It is however also possible for only a subset of the pressure regulating valves provided to be opened permanently and preferably to a maximum extent. Here, a number of pressure regulating valves opened permanently and preferably to a maximum extent may be selected in particular in a pressure-dependent manner.

An exemplary embodiment of the injection system is preferred which is characterized in that the injection system, in particular the control unit, is designed to switch—in particular from the normal operating mode—to the first operation type of the protective operating mode if the high pressure reaches or overshoots a first pressure threshold value or if a defect of the suction throttle is detected. The first pressure threshold value is in this case in particular selected such that an attainment or overshooting of said first pressure threshold value is an indication that pressure regulation of the high pressure is no longer possible by means of the suction throttle. This may in particular be an indication of a defect of the suction throttle. It is however also possible for a defect of the suction throttle to be detected without the high pressure firstly reaching or overshooting the first pressure threshold value. In this case, too, however, pressure regulation is no longer possible by means of the suction throttle. It is therefore expedient to switch to the first operation type of the protective operating mode and to subsequently regulate the high pressure by actuating the at least one first pressure regulating valve as pressure setting element.

Alternatively or in addition, it is preferably provided that a switch is made—in particular from the first operation type—to the second operation type if the high pressure reaches or overshoots a second pressure threshold value. The attainment or overshooting of the second pressure threshold value is in this case an indication that an actuation of the at least one first pressure regulating valve is no longer sufficient for the pressure regulation, such that the second operation type is advantageously selected, in which the at least one second pressure regulating valve is additionally actuated as pressure setting element in order to regulate the high pressure.

Alternatively or in addition, it is preferably provided that a switch is made—in particular from the second operation type—to the third operation type if the high pressure reaches or overshoots a third pressure threshold value or if a defect of a high-pressure sensor is detected. Here, the attainment or overshooting of the third pressure threshold value serves as an indication that an inadmissibly high pressure has been reached in the high-pressure accumulator, which high pressure poses a risk to the operational reliability of the injection system and in particular of the high-pressure accumulator, wherein there is in particular a risk of damage to the injection system, in particular to the high-pressure accumulator. If a defect of the high-pressure sensor is detected, then in principle it can no longer be ensured that the high pressure is being reliably regulated and in particular remains in a reliable range. Therefore, in both cases, it is expedient to select the third operation type and to preferably permanently discharge a maximum fuel volume flow from the high-pressure accumulator into the fuel reservoir via the pressure regulating valves. In this way, safe and reliable protection for the injection system in the event of an inadmissibly high pressure increase and/or in the event of a failure of the high-pressure sensor is ensured. In particular, on this basis, a mechanical pressure relief valve can be dispensed with.

The third pressure threshold value is preferably selected to be higher than the second pressure threshold value. The third pressure threshold value is preferably selected to be higher than the first pressure threshold value. The second pressure threshold value is preferably selected to be higher than the first pressure threshold value. The second pressure threshold value is particularly preferably selected to be higher than the first pressure threshold value, wherein the third pressure threshold value is selected to be higher than the second pressure threshold value.

By virtue of the first operation type being set when the high pressure reaches or overshoots the first pressure threshold value, it is ensured that said operation type is activated whenever—and preferably only when—a malfunction occurs in the first high-pressure regulating loop. For this purpose, the first pressure threshold value is preferably selected so as to be higher than a maximum pressure value for the high pressure that is typically realized during fault-free operation of the injection system.

In an exemplary embodiment of the injection system, it is for example possible for the high pressure to be regulated to a value of 2200 bar during operation. Here, a pressure reserve is provided for any occurring pressure fluctuations up to 2300 bar. In this case, the first pressure threshold value is preferably selected to be 2400 bar in order to prevent the first operation type being activated without a malfunction of the first high-pressure regulating loop or of the suction throttle being present. If such a malfunction however occurs—for example a cable breakage in the suction throttle plug connector, jamming of the suction throttle, an accumulation of dirt on said suction throttle, or a failure to remember to connect the suction throttle plug connector—the high pressure may, in particular in a relatively high engine speed range of the internal combustion engine, rise above the provided reserve level, in particular if the suction throttle is designed to be open when deenergized. In this case, the high pressure reaches or overshoots the first pressure threshold value, and the at least one first pressure regulating valve performs the regulation of the high pressure. Then, despite failure of the first high-pressure regulating loop, stable regulation of the high pressure remains possible, such that no impairment of emissions characteristics of the internal combustion engine occurs, wherein said internal combustion engine is at the same time reliably protected against an inadmissible rise of the high pressure.

The third pressure threshold value may for example be 2500 bar. This may correspond in particular to a pressure at which a mechanical pressure relief valve is designed to open. The function thereof will now preferably be replicated entirely by means of the pressure regulating valves.

As already stated, the second pressure threshold value is preferably selected to lie between the first pressure threshold value and the third pressure threshold value.

Altogether, in particular, the following situation arises: if the first high-pressure regulating loop and/or the suction throttle fails, and as a result the high pressure in the high-pressure accumulator increases, said high pressure is initially regulated in a range between the first pressure threshold value and the second pressure threshold value by means of the at least one first pressure regulating valve in the first operation type. If this no longer suffices for the regulation, and if the second pressure threshold value is reached or overshot, the at least one second pressure regulating valve is activated for pressure regulation in the second operation type. Through pressure regulation by means of the pressure regulating valves stable operation of the internal combustion engine with good emissions values can also be made possible. This is the case in particular in a low to medium engine speed range in which, owing to the low to medium engine speed of the high-pressure pump itself, a fuel quantity that is still manageable by means of regulation by means of the pressure regulating valves is delivered via a fully opened suction throttle from the fuel reservoir into the high-pressure accumulator. However, if the high pressure in the high-pressure accumulator rises inadmissibly high beyond the third pressure threshold value, for example in a high engine speed range of the internal combustion engine, pressure regulation is no longer possible by means of the pressure regulating valves. Said pressure regulating valves are rather then, in the third operation type, opened as fully as possible such that a large, preferably maximum fuel volume flow can be discharged into the fuel reservoir. This corresponds to the functionality of mechanical pressure relief valves that are otherwise provided.

Here, it is possible for the first operation type, the second operation type and the third operation type to be implemented sequentially one after the other, wherein, for example in the event of a defect occurring in the first high-pressure regulating loop, the first operation type is realized at an initially low engine speed of the internal combustion engine, wherein, as the engine speed rises, the second operation type and finally the third operation type are realized. It may however also be the case that the high pressure in the high-pressure accumulator rises abruptly beyond the second or third pressure threshold value, wherein in this case, the first operation type and/or the second operation type are/is, as it were, bypassed, with the second or third operation type rather being realized immediately.

For comparison with the pressure threshold values, use is preferably made of a dynamic rail pressure which results from a filtering, in particular with a relatively short time constant, of the high pressure measured by means of a high-pressure sensor. It is however alternatively also possible for the measured high pressure to be compared directly with the pressure threshold values. By contrast, the filtering has the advantage that—albeit seldomly occurring—overshoots beyond the pressure threshold values do not lead directly to switching of the operation types.

In a preferred embodiment of the method, a control variable for the pressure regulating valves in the first and/or in the second operation type is limited in a manner dependent on the high pressure. This has the advantage that a pressure regulating valve is opened no further than is required for a maximum discharge that is actually expedient in the presence of a given high pressure.

In this way, overloading of the pressure regulating valve can be avoided. For the limitation of the control variable, use is preferably made of a characteristic curve in which a maximum volume flow of the pressure regulating valve is stored in a manner dependent on the high pressure.

Upon a switch from the normal operating mode into the first operation type of the protective operating mode, it is the case in a preferred embodiment of the method that an integrating component of a pressure regulator of the second high-pressure regulating loop which is provided for the actuation of the pressure regulating valve is initialized with an actuation value which was used for the actuation of the pressure regulating valve during the normal operating mode immediately prior to the switchover to the protective operating mode. In this way, a smooth, disturbance-free and continuous transition in the pressure regulation between the regulation by means of the first high-pressure regulating loop in the normal operating mode and the regulation by means of the second high-pressure regulating loop in the protective operating mode is ensured. In particular, this prevents step changes in the high pressure from occurring, which would lead to unstable operation of the internal combustion engine.

Alternatively or in addition, it is preferable that, for the pressure regulating valves in the third operation type of the protective operating mode, a standstill function is set, wherein the pressure regulating valves are not actuated in the standstill function. This is the case in particular if use is made of a pressure regulating valve which is open when deenergized. By virtue of the fact that the pressure regulating valves are then not actuated, that is to say not energized, in the standstill function, maximum opening of said pressure regulating valves is realized, such that a maximum fuel volume flow is discharged from the high-pressure accumulator into the fuel reservoir via the pressure regulating valves. In this way, the pressure regulating valves can fully perform the functionality of a mechanical pressure relief valve that is otherwise provided, such that the mechanical pressure relief valve can be dispensed with. Here, the design of the pressure regulating valves so as to be open when deenergized has the advantage that said pressure regulating valves reliably fully open even when they are no longer energized owing to a defect.

A transition from the normal function to the standstill function is preferably performed if the high pressure, in particular the dynamic rail pressure, reaches or overshoots the third pressure threshold value, or if a defect of the high-pressure sensor is detected. If the high-pressure sensor is defective, the high pressure can no longer be regulated, and it is also no longer possible to detect an inadmissibly high pressure in the high-pressure accumulator. Therefore, in this case, for safety reasons, the standstill function is set for the pressure regulating valves, such that said pressure regulating valves open to a maximum extent and thus place the injection system into a safe state which corresponds to a state in which, in the prior art, the mechanical pressure relief valve would be open. It is then no longer possible for an inadmissible increase of the high pressure to occur. The standstill function is preferably also set, proceeding from the normal function, if it is detected that the internal combustion engine is at a standstill. In particular if the engine speed of the internal combustion engine falls below a predetermined value for a predetermined time, it is identified that the internal combustion engine is at a standstill, and the standstill function for the pressure regulating valves is set. This is the case in particular when the internal combustion engine is shut down. A transition between the standstill function and the normal function is preferably performed, upon a start-up of the internal combustion engine, when it is detected that the internal combustion engine is running, wherein, at the same time, the high pressure overshoots a starting pressure value. It is thus preferably the case that a certain minimum build-up of pressure in the high-pressure accumulator takes place initially before a pressure regulating valve, in the normal function, is actuated for generating the high-pressure disturbance variable. The fact that the internal combustion engine is running can be identified preferably by virtue of the fact that a predetermined threshold engine speed is overshot for a predetermined time.

An exemplary embodiment of the injection system is also preferred which is characterized in that the injection system, in particular the control unit, is designed to, in at least one of the three operation types of the protective operating mode, in particular in the third operation type of the protective operating mode, actuate the suction throttle such that it assumes a permanently open position. Owing to the pressure regulating valves being opened in particular to the greatest possible extent in the third operation type, it is possible for the pressure in the high-pressure accumulator to fall to a great extent. While it is then the case in a high engine speed range of the internal combustion engine that it is nevertheless still possible to provide an adequate high pressure for the operation of the internal combustion engine, it may, in the case of the suction throttle being opened to an insufficient extent in a medium or low engine speed range, be the case that the high pressure in the high-pressure accumulator falls to such an extent that it is no longer possible for enough fuel to be injected via the injectors. In such a case, the internal combustion engine will stall. To prevent this, in the third operation type, the suction throttle is, in a type of emergency running operating mode, permanently opened, in particular actuated for permanently open operation, in order to ensure that, even in the medium and low engine speed range of the internal combustion engine, it is still possible for enough fuel to be delivered into the high-pressure accumulator in order to be able to maintain operation of the internal combustion engine. Use is preferably made of a suction throttle which is open when deenergized. Therefore, in the third operation type, the suction throttle is preferably actuated with a low current in relation to its maximum closing current, for example with 0.5 A, or is even not actuated, that is to say not energized. Here, when not energized, said suction throttle is opened to the maximum extent.

Alternatively or in addition, in the first and/or in the second operation type of the protective operating mode, the suction throttle is permanently opened, preferably actuated for permanently open operation, in particular is not energized or energized with only a low current. In this way, in particular in a situation in which the first or second operation type is activated as a result of an overshoot of the high pressure in the case of an intact suction throttle, twofold simultaneous regulation of the high pressure both by means of the pressure regulating valves and by means of the suction throttle is prevented.

The control unit is preferably set up for filtering the measured high pressure, in particular for filtering it with a first, relatively long time constant, in order to calculate an actual high pressure that is to be used in the context of the pressure regulation, and for filtering the measured high pressure with a second, relatively short time constant, in order to calculate a dynamic rail pressure, which is in particular compared with the pressure threshold values.

An exemplary embodiment of the injection system is preferred which is characterized in that at least one of the at least two pressure regulating valves is designed to be open when deenergized. It is particularly preferable for all of the pressure regulating valves to be designed to be open when deenergized. This embodiment has the advantage that a pressure regulating valve which is open when deenergized is opened to a maximum extent when it is not actuated or energized, which permits particularly safe and reliable operation in particular if a mechanical pressure relief valve is dispensed with. An inadmissible rise of the high pressure in the high-pressure accumulator can then be avoided even if an energization of the pressure regulating valve is not possible owing to a technical fault.

Alternatively or in addition, it is possible for at least one pressure regulating valve of the at least two pressure regulating valves to be designed to be closed when unpressurized and deenergized. In particular, it is possible for all of the pressure regulating valves to be designed to be closed when unpressurized and deenergized. Such a pressure regulating valve is designed so as to be closed when the pressure prevailing in the high-pressure accumulator, that is to say the rail pressure, is lower than a predetermined opening pressure value. The high pressure prevails at an inlet of the pressure regulating valve when said pressure regulating valve is installed correctly on the injection system. The pressure regulating valve opens when, in the deenergized state, the pressure prevailing at the inlet side reaches or overshoots the opening pressure value. Thus, if the pressure regulating valve is unpressurized at the inlet side and deenergized, said pressure regulating valve is preloaded into a closed state, for example by means of a mechanical preload element. If the inlet-side pressure reaches or overshoots the opening pressure value, and if the pressure regulating valve is not energized, said pressure regulating valve is opened, preferably counter to the force of the preload element, such that said pressure regulating valve is then open when deenergized in the presence of the opening pressure value and higher inlet pressures. If the pressure regulating valve is energized in said state, it closes in a manner dependent on the current with which it is actuated. Here, said pressure regulating valve is closed to the maximum extent when it is actuated with a predetermined maximum current value. If said pressure regulating valve is no longer energized, or if the energization fails, said pressure regulating valve fully opens again, wherein said pressure regulating valve closes if the inlet-side pressure falls below the opening pressure value.

The opening pressure value is preferably selected so as to be lower than a minimum high pressure reached in a normal regulating operating mode of the injection system. In particular, in the specific example mentioned above in conjunction with the operation types of the protective operating mode, it is possible for the opening pressure value to be 850 bar. In this case, it is also preferable for the starting pressure value, at which, upon starting of the internal combustion engine, a transition from the standstill function of the pressure regulating valve to the normal function is performed, to be selected so as to lie approximately in the range of the opening pressure value, wherein said starting pressure value is preferably selected to be slightly lower in order to ensure that the pressure regulating valve is always actuated as soon as it opens as a result of the opening pressure value being reached or overshot. Here, allowance may also be made for tolerances of the pressure regulating valve. For example, it may be the case that the starting pressure value is selected to be 600 bar.

This yields the following functionality: if the internal combustion engine is at a standstill, and accordingly if the high pressure in the high-pressure accumulator has fallen below the opening pressure value, the pressure regulating valve is arranged in its standstill function, and is thus deenergized and unpressurized. Said pressure regulating valve is accordingly closed. Now, if the internal combustion engine starts, the closed pressure regulating valve firstly permits a rapid and reliable pressure build-up in the high-pressure accumulator, because no fuel is discharged via the pressure regulating valve into the fuel reservoir. Typically, it is now the case that the high pressure in the high-pressure accumulator firstly reaches the starting pressure value, whereby a transition from the standstill function to the normal function is performed, wherein the pressure regulating valve is consequently actuated. In this case, said pressure regulating valve however typically remains closed, because the opening pressure value has not yet been reached. The high pressure in the high-pressure accumulator rises further and finally also overshoots the opening pressure value, wherein the pressure regulating valve then opens and—in the absence of actuation—would also be open when deenergized. As a result of energization and corresponding actuation of the pressure regulating valve, it is now possible for the degree of opening of said pressure regulating valve to be influenced, and in particular for said pressure regulating valve to be closed further by means of increased energization or opened further by means of reduced energization. If, in the third operation type of the protective operating mode, a transition to the standstill function is performed again, the pressure regulating valve is no longer actuated, wherein, in this case, at the moment of the transition, a high pressure prevails which is higher than the third pressure threshold value, that is to say is in particular very much higher than the opening pressure value. Thus, in this state, the pressure regulating valve is deenergized and open, and thus, owing to the absence of actuation, discharges a maximum fuel volume flow from the high-pressure accumulator into the fuel reservoir, such that said pressure regulating valve safely and reliably performs its protective function. In this way, it is readily possible to dispense with a mechanical pressure relief valve. The pressure regulating valve closes again only when the high pressure falls below the opening pressure value. In this way, safe operation of the injection system is realized, and there is no longer a risk of damage or of an inadmissibly high pressure.

An exemplary embodiment of the injection system is also preferred which is characterized in that the injection system, in particular the control unit, is designed to generate a first actuation signal and a second actuation signal and to actuate the at least one first pressure regulating valve and the at least one second pressure regulating valve alternately with the first actuation signal and the second actuation signal. In particular, it is provided here that, at a first point in time, the at least one first pressure regulating valve is actuated with the first actuation signal, wherein the at least one second pressure regulating valve is simultaneously actuated with the second actuation signal, wherein, at a second point in time, the at least one first pressure regulating valve is actuated with the second actuation signal, wherein, at the same time, the at least one second pressure regulating valve is actuated with the first actuation signal. This embodiment has the advantage that the various pressure regulating valves can be utilized uniformly. This applies in particular to a situation in which only one of the pressure regulating valves is actuated, such that one of the actuation signals is active and the other is permanently inactive. Without alternate actuation, it would then be the case that only one of the pressure regulating valves is permanently actuated and thus loaded, whereas the other pressure regulating valve would not be used. Through alternate actuation, it can be ensured even in such a situation that uniform utilization of the pressure regulating valves is ensured, such that the maintenance and exchange times thereof can be homogenized and altogether longer service intervals can be realized. Also, in a situation in which both the first actuation signal and the second actuation signal are active, any differences that may still exist in the actuation signals are, by means of alternate actuation, compensated and distributed homogeneously between the various pressure regulating valves. It is self-evidently possible for the control unit to be designed to generate more than two actuation signals, in particular for more than two pressure regulating valves. Here, it is possible for the various actuation signals to be assigned differently to the various pressure regulating valves in alternating, in particular cyclic fashion.

It is preferably the case that, for each pressure regulating valve, a regulator for energizing the pressure regulating valve is provided, wherein the regulators are also assigned alternately to the various pressure regulating valves. Here, in particular, the currents detected at the pressure regulating valves are likewise switched over, such that these can be detected by the correct, respectively presently responsible regulators and used for the regulation.

A switchover of the actuation signals to the various pressure regulating valves is preferably performed only when the internal combustion engine is at a standstill. Otherwise, faults can briefly occur during the operation of the internal combustion engine.

The switchover of the actuation signals is preferably performed after a predetermined operating time of the injection system has elapsed, in particular after a predetermined number of operating hours has elapsed. For example, a switchover may be performed after 5000 operating hours. If, after the predetermined number of operating hours has elapsed, it is detected that the internal combustion engine is not at a standstill, the next standstill situation of the internal combustion engine is preferably awaited before a switchover is performed.

An exemplary embodiment of the injection system is also preferred which is characterized in that it is free from a mechanical pressure relief valve. In particular, the injection valve has no mechanical pressure relief valve. Here, it is possible for a mechanical pressure relief valve to be omitted because a function of protecting the injection system against inadmissibly high pressures can be realized reliably and efficiently by means of the pressure regulating valves. Costs and structural space associated with a mechanical pressure relief valve can thus be saved.

The object is also achieved through the provision of an internal combustion engine which has an injection system according to one of the exemplary embodiments described above. The advantages that have already been discussed in conjunction with the injection system are realized in conjunction with the internal combustion engine.

The control unit is preferably in the form of an engine control unit (ECU) of the internal combustion engine. It is however alternatively also possible for a separate control unit to be provided specifically for controlling the injection system.

The injection system preferably has a multiplicity of injectors, wherein said injection system has precisely one and only one high-pressure accumulator or alternatively two high-pressure accumulators—for V engines—or else three high-pressure accumulators—for W engines—or possibly another configuration of high-pressure accumulators for another configuration of combustion chambers of the internal combustion engine, wherein the various injectors are fluidically connected to the one or more high-pressure accumulator(s). In particular, a multiplicity of injectors is connected to a common high-pressure accumulator in each case. The common high-pressure accumulator(s) is/are in this case in the form of a so-called common strip, in particular a rail, wherein the injection system is preferably in the form of a common-rail injection system.

The internal combustion engine is preferably in the form of a reciprocating-piston engine. It is possible for the internal combustion engine to be designed for driving a passenger motor vehicle, a heavy goods vehicle or a utility vehicle. In a preferred exemplary embodiment, the internal combustion engine serves for driving in particular heavy land vehicles or watercraft, for example mining vehicles or trains, wherein the internal combustion engine is used in a locomotive or motor coach, or ships. It is also possible for the internal combustion engine to be used for driving a vehicle which serves in the defense sector, for example a tank. An exemplary embodiment of the internal combustion engine is preferably also used in a static configuration, for example for static energy supply in emergency power operation, continuous load operation or peak load operation, wherein in this case, the internal combustion engine preferably drives a generator. It is also possible for the internal combustion engine to be used in a static configuration for the drive of auxiliary assemblies, for example fire-extinguishing pumps on drilling platforms. Furthermore, the internal combustion engine may be used in the field of the delivery of fossil resources and in particular fuels, for example oil and/or gas. It is also possible for the internal combustion engine to be used in the industrial sector or in the construction sector, for example in a construction or building machine, for example in a crane or in an excavator. The internal combustion engine is preferably in the form of a diesel engine, a gasoline engine or a gas engine for operation with natural gas, biogas, special gas or some other suitable gas. In particular if the internal combustion engine is in the form of a gas engine, it is suitable for use in a combined heat and power plant for static energy generation.

An exemplary embodiment of the internal combustion engine is preferred in which the latter is in the form of a large engine. Here, the internal combustion engine preferably has eight combustion chambers or more, in particular ten combustion chambers, twelve combustion chambers, fourteen combustion chambers, sixteen combustion chambers, eighteen combustion chambers or twenty combustion chambers. An internal combustion engine is particularly preferred which is in the form of a reciprocating-piston engine with twenty cylinders.

By means of the embodiment of the injection system proposed here, it is possible in particular for identical pressure regulating valves to be installed for a multiplicity of different internal combustion engines with a multiplicity of different configurations and numbers of cylinders, wherein it is merely necessary for a number of installed pressure regulating valves to be scaled with the size of the internal combustion engine.

The invention also includes a method for operating an internal combustion engine having an injection system. Here, the method is characterized in that it is set up for operating an internal combustion engine having an injection system according to one of the exemplary embodiments described above. The method is characterized in particular by at least one method step which has been discussed above explicitly or implicitly in conjunction with the injection system.

The invention will be discussed in more detail below on the basis of the drawing, in which:

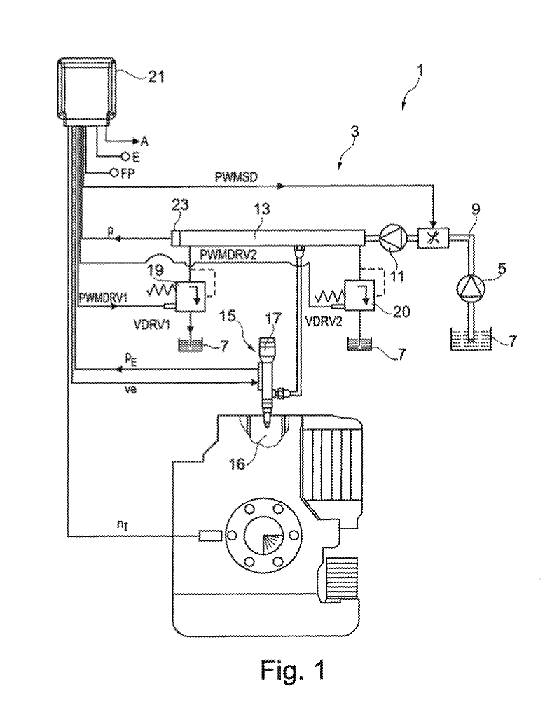

FIG. 1 is a schematic illustration of an exemplary embodiment of an internal combustion engine having an injection system;

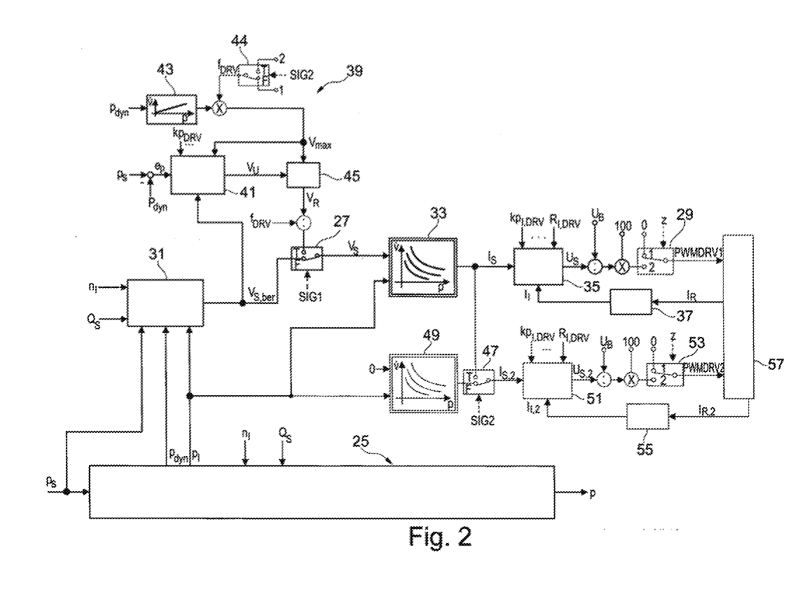

FIG. 2 is a first schematic detail illustration of an actuation of the injection system;

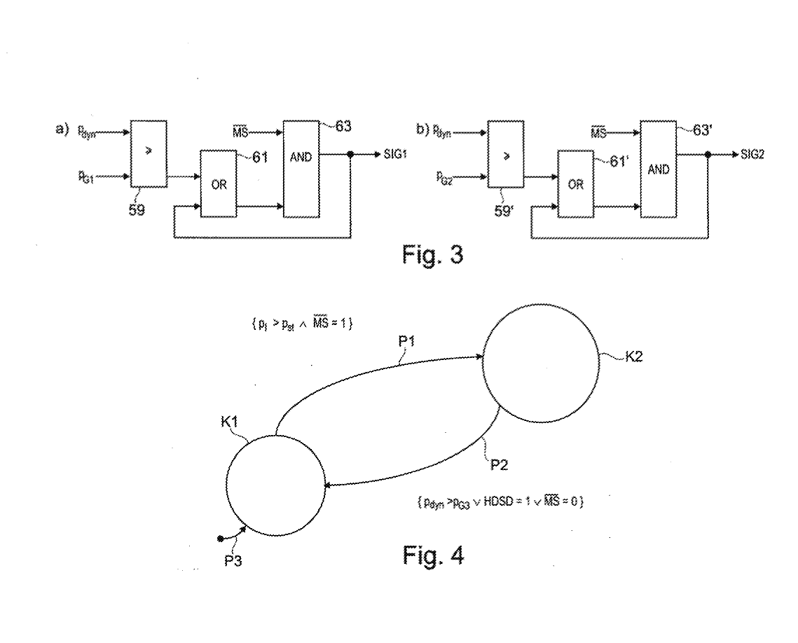

FIG. 3 is a second schematic detail illustration of an actuation of the injection system;

FIG. 4 is a third schematic detail illustration of an actuation of the injection system;

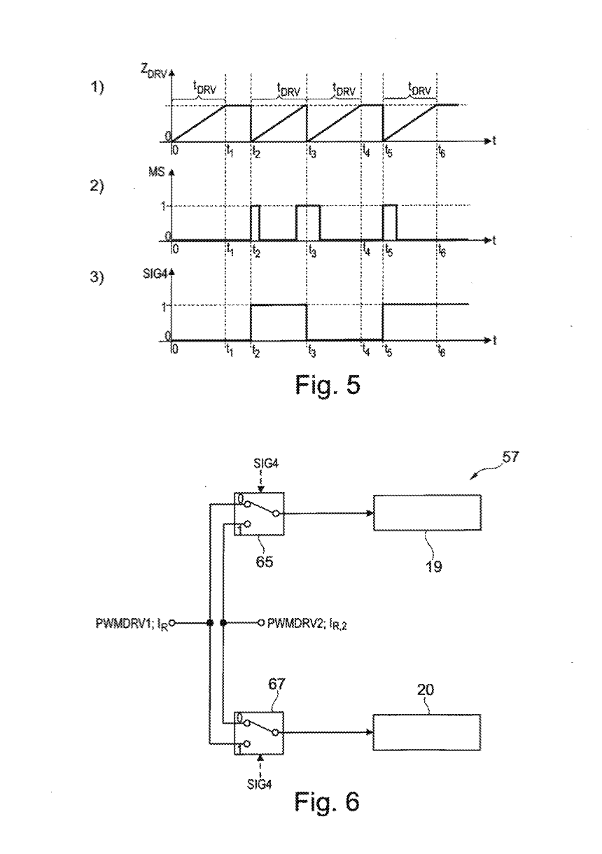

FIG. 5 is a fourth schematic detail illustration of an actuation of the injection system;

FIG. 6 is a fifth schematic detail illustration of an actuation of the injection system;

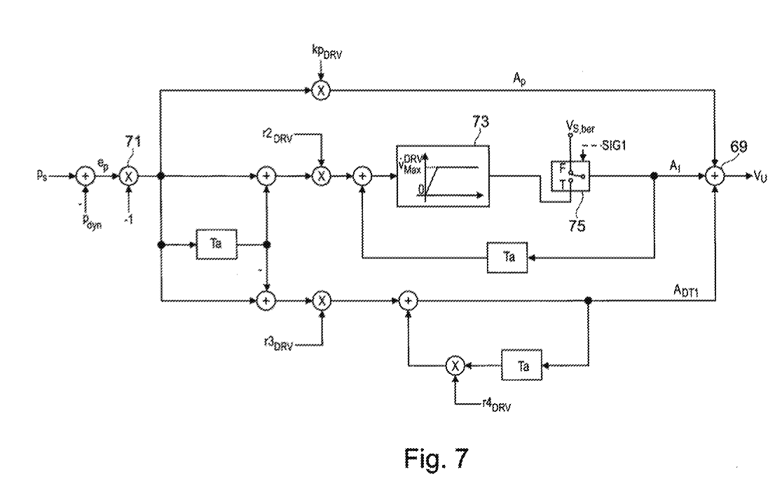

FIG. 7 is a sixth schematic detail illustration of an actuation of the injection system;

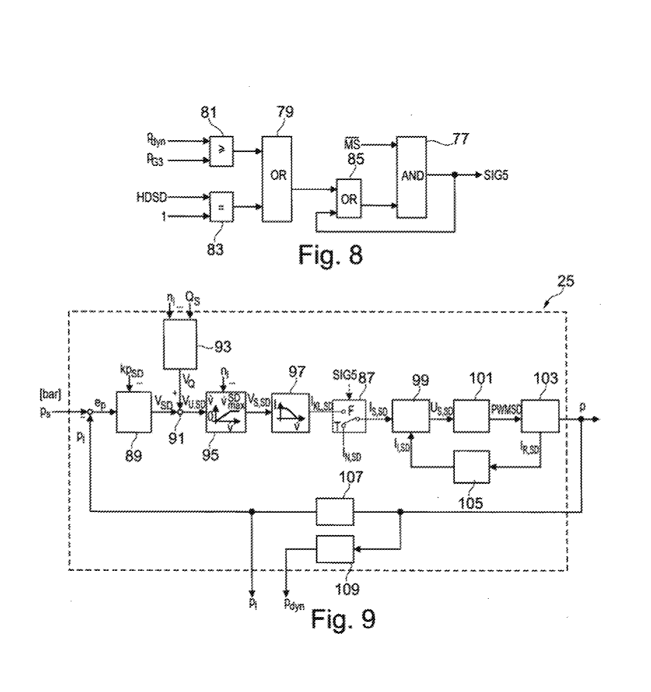

FIG. 8 is a seventh schematic detail illustration of an actuation of the injection system; and

FIG. 9 is an eighth schematic detail illustration of an actuation of the injection system.

FIG. 1 is a schematic illustration of an exemplary embodiment of an internal combustion engine 1 which has an injection system 3. Said injection system is preferably in the form of a common-rail injection system. Said injection system has a low-pressure pump 5 for the delivery of fuel from a fuel reservoir 7, an adjustable, low-pressure-side suction throttle 9 for influencing a fuel volume flow flowing through said low-pressure pump, a high-pressure pump 11 for delivering the fuel at elevated pressure into a high-pressure accumulator 13, the high-pressure accumulator 13 for storing the fuel, and a multiplicity of injectors 15 for injecting the fuel into combustion chambers 16 of the internal combustion engine 1. It is optionally possible for the injection system 3 to also be formed with individual accumulators, wherein then, it is for example the case that an individual accumulator 17 as an additional buffer volume is integrated in the injector 15. A first, in particular electrically actuable pressure regulating valve 19 is provided, by means of which the high-pressure accumulator 13 is fluidically connected to the fuel reservoir 7. By means of the position of the first pressure regulating valve 19, a fuel volume flow which is discharged from the high-pressure accumulator 13 into the fuel reservoir 7 is defined. Said fuel volume flow is denoted in FIG. 1 and in the following text by VDRV1, and represents a high-pressure disturbance variable of the injection system 3.

The injection system 3 has a second, in particular electrically actuable pressure regulating valve 20, by means of which the high-pressure accumulator 13 is likewise fluidically connected to the fuel reservoir 7. The two pressure regulating valves 19, 20 are accordingly in particular arranged fluidically in parallel with respect to one another. By means of the second pressure regulating valve 20, too, a fuel volume flow can be defined which can be discharged from the high-pressure accumulator 13 into the fuel reservoir 7. Said fuel volume flow is denoted in FIG. 1 and in the following text by VDRV2.

The injection system 3 has no mechanical pressure relief valve, such as is commonly provided in the prior art so as to then connect the high-pressure accumulator 13 to the fuel reservoir 7. According to the invention, the mechanical pressure relief valve can be dispensed with because its function is performed entirely by the pressure regulating valves 19, 20.

It is possible for the injection system 3 to have more than two pressure regulating valves 19, 20. For the sake of a simpler illustration, however, the functioning of the injection system 1 according to the invention will be discussed below on the basis of the exemplary embodiment illustrated here, which has exactly two pressure regulating valves 19, 20.

The operation of the internal combustion engine 1 is defined by an electronic control unit 21 which is preferably in the form of an engine control unit (ECU) of the internal combustion engine 1. The electronic control unit 21 comprises the conventional constituent parts of a microcomputer system, for example a microprocessor, I/O components, buffers and memory components (EEPROM, RAM). The operating data relevant for the operation of the internal combustion engine 1 are stored in the memory components in the form of characteristic maps/characteristic curves. Using these, the electronic control unit 21 calculates output variables from input variables. In FIG. 1, the following input variables are illustrated by way of example: a measured, still-unfiltered high pressure p, which prevails in the high-pressure accumulator 13 and which is measured by means of a high-pressure sensor 23, a present engine speed a signal FP relating to the power demanded by an operator of the internal combustion engine 1, and an input variable E. The input variable E preferably encompasses further sensor signals, for example a charge-air pressure of an exhaust-gas turbocharger. In the case of an injection system 3 with individual accumulators 17, an individual-accumulator pressure p_{E} is preferably an additional input variable of the control unit 21.

As output variables of the electronic control unit 21, FIG. 1 illustrates, by way of example, a signal PWMSD for the actuation of the suction throttle 9 as pressure setting element, a signal ve for the actuation of the injectors 15, said signal predefining in particular a start of injection and/or an end of injection or else an injection duration, a first signal PWMDRV1 for the actuation of a first pressure regulating valve of the two pressure regulating valves 19, 20 and a second signal PWMDRV2 for the actuation of a second pressure regulating valve of the two pressure regulating valves 19, 20. As will be discussed in more detail below, the assignment, illustrated in FIG. 1, of the first signal PWMDRV1 to the first pressure regulating valve 19 and of the second signal PWMDRV2 to the second pressure regulating valve 20 is not fixed at all times, it rather being the case that the pressure regulating valves 19, 20 are preferably actuated with the signals PWMDRV1, PWMDRV2 alternately. The signals PWMDRV1, PWMDRV2 are preferably pulse-width-modulated signals by means of which the position of a pressure regulating valve 19, 20 and thus the volume flow VDRV1, VDRV2 respectively associated with the pressure regulating valve 19, 20 can be defined. Also illustrated in FIG. 1 is an output variable A, which represents further control signals for the control and/or regulation of the internal combustion engine 1, for example a control signal for the activation of a second exhaust-gas turbocharger in the case of a sequential supercharging arrangement.

FIG. 2 is a first schematic illustration of an embodiment of the method. Here, below, the functioning of the method will firstly be discussed for the actuation of only one of the pressure regulating valves 19, 20, wherein the functionality that is added through the addition of a further pressure regulating valve 20, 19 will then be discussed in a next step. A first high-pressure regulating loop 25 is provided, by means of which, in a normal operating mode of the injection system 3, the high pressure in the high-pressure accumulator 13 is regulated by means of the suction throttle 9 as pressure setting element. The first high-pressure regulating loop 25 will be discussed in more detail in conjunction with FIG. 9, where it is presented in detail. The first high-pressure regulating loop 25 has, as an input variable, a setpoint high pressure p_{S} for the injection system 3. Said setpoint high pressure is preferably read out from a characteristic map in a manner dependent on the engine speed n_{I} of the internal combustion engine 1, a load or torque demand on the internal combustion engine 1, and/or in a manner dependent on further variables, which serve in particular for correction purposes. Further input variables of the first high-pressure regulating loop 25 are in particular the engine speed n_{I} of the internal combustion engine 1 and a setpoint injection quantity Q_{S}, which is in particular likewise read out from a characteristic map. As an output variable, the first high-pressure regulating loop 25 has, in particular, the high pressure p measured by the high-pressure sensor 23, said high pressure preferably being subjected to a first filtering with a relatively long time constant in order to determine an actual high pressure p_{I}, wherein said high pressure is preferably simultaneously subjected to a second filtering with a relatively short time constant in order to calculate a dynamic rail pressure p_{dyn}. Said two pressure values p_{I}, p_{dyn} constitute further output variables of the first high-pressure regulating loop 25.

FIG. 2 illustrates in particular the actuation of a first pressure regulating valve of the two pressure regulating valves 19, 20, for example the actuation of the first pressure regulating valve 19. It is preferably the case that a first switching element 27 is provided by means of which a switchover between the normal operating mode and a first operation type of a protective operating mode can be performed in a manner dependent on a first logic signal SIG1. The switching element 27 is preferably realized entirely on an electronic or software level. Here, the functionality described below is preferably switched over in a manner dependent on a value of a variable corresponding to the first logic signal SIG1, which variable is in particular in the form of a so-called flag and can assume the values “true” or “false”. It is however self-evidently alternatively also possible for the switching element 27 to be in the form of a physical switch, for example a relay. Said switch can then be switched for example in a manner dependent on a level of an electrical signal. In the case of the specific embodiment illustrated here, the normal operating mode is set if the first logic signal SIG1 has the value “false”. By contrast, the operation type of the protective operating mode is set if the first logic signal SIG1 has the value “true”.

A second switching element 29 is provided which is set up for switching the first actuation signal PWMDRV1 between two modes, wherein in particular, a pressure regulating valve 19, 20 that is actuated with the first actuation signal PWMDRV1 can be switched from a normal function to a standstill function and back. Here, the second switching element 29 is controlled in a manner dependent on a second logic signal Z or in a manner dependent on the value of a corresponding variable. The second switching element 29 may be in the form of a virtual, in particular software-based switching element which switches between the normal function and the standstill function in a manner dependent on the value of a variable which is in particular in the form of a flag. It is however alternatively also possible for the second switching element to be in the form of a physical switch, for example a relay, which switches in a manner dependent on a signal value of an electrical signal. In the specific embodiment illustrated here, the second logic signal Z corresponds to a state variable which can assume the values 1 for a first state and 2 for a second state. Here, the normal function for the actuated pressure regulating valve 19, 20 is set if the second logic signal Z assumes the value 2, wherein the standstill function is set if the second logic signal Z assumes the value 1. It is self-evidently possible for the second logic signal Z to be defined differently, in particular such that a corresponding variable can assume the values 0 and 1.

Firstly, a description will be given of the actuation of a first pressure regulating valve 19, 20 in the normal operating mode and in the case of the normal function having been set. A first calculation element 31 is provided which outputs a calculated setpoint volume flow V_{S,ber} as an output variable, wherein the present engine speed n_{I}, the setpoint injection quantity Q_{S}, the setpoint high pressure p_{S}, the dynamic rail pressure p_{dyn} and the actual high pressure p_{I} are input as input variables into the first calculation element 31. The functioning of the calculation element 31 is described in detail in the German patents DE 10 2009 031 528 B3 and DE 10 2009 031 527 B3. Here, it is shown in particular that, in a low-load range, for example during idle operation of the internal combustion engine 1, a positive value is calculated for a steady-state setpoint volume flow, whereas a steady-state setpoint volume flow of 0 is calculated in a normal operating range. The steady-state setpoint volume flow is preferably corrected by adding a dynamic setpoint volume flow, which in turn is calculated by means of a dynamic correction in a manner dependent on the setpoint high pressure p_{S}, the actual high pressure p_{I} and the dynamic rail pressure p_{dyn}. The calculated setpoint volume flow V_{S,ber} is finally the sum of the steady-state setpoint volume flow and the dynamic setpoint volume flow. The calculated setpoint volume flow V_{S,ber} is thus a resultant setpoint volume flow.

In the normal operating mode, when the first logic signal SIG1 has the value “false”, the calculated setpoint volume flow V_{S,ber} is transmitted as setpoint volume flow V_{S} to a pressure regulating valve characteristic map 33. Here, as described in the German patent DE 10 2009 031 528 B3, the pressure regulating valve characteristic map 33 replicates an inverse characteristic of a pressure regulating valve 19, 20 that is used. In a preferred embodiment, the injection system has identical pressure regulating valves 19, 20, such that the same pressure regulating valve characteristic map 33 can be used for each of the pressure regulating valves 19, 20. It is however alternatively also possible to use different pressure regulating valves 19, 20, wherein then, for each pressure regulating valve 19, 20, a pressure regulating valve characteristic map separately assigned thereto is used. An output variable of the pressure regulating valve characteristic map 33 is a pressure regulating valve setpoint current I_{S}; input variables are the setpoint volume flow V_{S} to be discharged and also the actual high pressure p_{I}.

In an alternative embodiment of the method, it is also possible for the setpoint volume flow V_{S} not to be calculated by means of the first calculation element 31 but to be predefined as a constant in the normal operating mode.

The pressure regulating valve setpoint current is fed to a first current regulator 35 which has the task of regulating the current for the actuation of the pressure regulating valve 19, 20. Further input variables of the first current regulator 35 are for example a proportional coefficient kp_{I,DRV} and an ohmic resistance R_{I,DRV} of the pressure regulating valve 19, 20. An output variable of the first current regulator 35 is a first setpoint voltage U_{S} for the pressure regulating valve 19, 20, which setpoint voltage is, in relation to an operating voltage U_{B}, converted in conventional fashion into an activation duration for the first, pulse-width-modulated signal PWMDRV1 for the actuation of the pressure regulating valve 19, 20, and is fed to said pressure regulating valve in the normal function, that is to say when the second logic signal Z has the value 2. For the current regulation, the current at the pressure regulating valve 19, 20 actuated with the first actuation signal PWMDRV1 is measured as first current variable I_{R}, filtered in a first current filter 37 and supplied as a first filtered actual current I_{I} to the current regulator 35 again.

As already indicated, the activation duration in the form of the first, pulse-width-modulated actuation signal PWMDRV1 is, for the actuation of a pressure regulating valve 19, 20, calculated in a conventional manner from the first setpoint voltage U_{S} and the operating voltage U_{B} in accordance with the following equation:

PWMDRV1=(U_{S}/U_{B})×100. (1)

In this way, in the normal operating mode, a high-pressure disturbance variable, specifically the discharged setpoint volume flow V_{S}, is generated by means of one of the pressure regulating valves 19, 20.

If the first logic signal SIG1 assumes the value “true”, the first switching element 27 switches over from the normal operating mode to the protective operating mode. The conditions under which this is performed will be discussed in conjunction with FIG. 3. With regard to the actuation of the pressure regulating valve 19, 20, there is no difference in the first and second operation type of the protective operating mode, because it is also the case here that the pressure regulating valve 19, 20 is actuated with the setpoint volume flow V_{S}, in any case for as long as the normal function is set by means of the switching element 29. In this respect, in FIG. 2, to the right of the switching element 27, there is no change in relation to the explanations given above. However, the setpoint volume flow V_{S} is calculated differently in the first and second operation type of the protective operating mode than in the normal operating mode, specifically by means of a second high-pressure regulating loop 39.

In this case, the setpoint volume flow V_{S} is set to be identical to a limited output volume flow V_{R} from a pressure regulating valve pressure regulator 41—aside from a factor f_{DRV} discussed in more detail below. This corresponds to the upper switching position of the first switching element 27. The pressure regulating valve pressure regulator 41 has, as an input variable, a high-pressure regulating deviation eₚ which is calculated as the difference between the setpoint high pressure p_{S} and the dynamic rail pressure p_{dyn}. Further input variables of the pressure regulating valve pressure regulator 41 are preferably a maximum volume flow Vₘₐₓ for the pressure regulating valve 19, 20, the setpoint volume flow V_{S,ber} calculated in the first calculation element 31, and/or a proportional coefficient kp_{DRV}. The pressure regulating valve pressure regulator 41 is preferably implemented as a PI(DT₁) algorithm which will be discussed in more detail in FIG. 7. Here, as will be discussed further, an integrating component (I component) is, at the time at which the first switching element 27 is switched over from its lower switching position illustrated in FIG. 2 into its upper switching position, initialized with the calculated setpoint volume flow V_{S,ber}. The I component of the pressure regulating valve pressure regulator 41 is upwardly limited to the maximum volume flow Vₘₐₓ for the pressure regulating valve 19, 20. Here, the maximum volume flow Vₘₐₓ is preferably—aside from the factor f_{DRV}—an output variable of a two-dimensional characteristic curve 43 which has the maximum volume flow passing through the pressure regulating valve 19, 20 as a function of the high pressure, wherein the characteristic curve 43 receives the dynamic rail pressure p_{dyn} as input variable. As already indicated, it is assumed in this exemplary embodiment that the pressure regulating valves 19, 20 are of identical form, such that an identical characteristic curve 43 can be used for both pressure regulating valves. It is however also possible for different pressure regulating valves 19, 20 to be used, wherein then, a separate characteristic curve 43 is used for each of the pressure regulating valves 19, 20. The direct output variable of the pressure regulating valve pressure regulator 41 is an unlimited volume flow V_{U} which is limited to the maximum volume flow Vₘₐₓ in a limitation element 45. The limitation element 45 finally outputs, as output variable, the limited setpoint volume flow V_{R}. Then, using this, aside from the factor f_{DRV} discussed in more detail below, the pressure regulating valve 19, 20 is actuated as setpoint volume flow V_{S} by virtue of the setpoint volume flow V_{S} being supplied, in the manner already described, to the pressure regulating valve characteristic map 33.

Accordingly, in this way, in the first operation type of the protective operating mode, an actuation of a pressure regulating valve 19, 20 as pressure setting element in order to regulate the high pressure in the high-pressure accumulator 13 is performed by means of the second high-pressure regulating loop 39.

The functionality that is added through the addition of a second pressure regulating valve 20, 19 will now be discussed below.

As will also be discussed in more detail in conjunction with FIG. 3, the first logic signal SIG1 assumes the logic value “true” if the dynamic rail pressure P_{dyn} reaches a first pressure threshold value p_{G1}, for example as a result of a cable breakage of the suction throttle plug connector. As a result, the first switching element 27 switches into the upper switching position illustrated in FIG. 2, such that the high pressure is now regulated by means of the second high-pressure regulating loop 39 and one of the pressure regulating valves 19, 20. As will likewise be discussed in more detail in conjunction with FIG. 3, a third logic signal SIG2 has the value “false” if the dynamic rail pressure p_{dyn} has not yet reached a second pressure threshold value p_{G2}. A second pressure regulating valve setpoint current I_{S,2} for a second pressure regulating valve 20, 19 is then read out from a second pressure regulating valve characteristic map 49 which has the actual high pressure p_{I} and the value zero for the setpoint volume flow as input variables. If the two pressure regulating valves 19, 20 are of identical design, the second pressure regulating valve characteristic map 49 is identical to the first pressure regulating valve characteristic map 33 and differs only with regard to the fact that the setpoint volume flow that is input is set to zero. If different pressure regulating valves 19, 20 are used, the two pressure regulating valve characteristic maps 33, 49 may differ. By virtue of the fact that the second pressure regulating valve characteristic map 49 has the value zero as an input setpoint volume flow, the pressure regulating valve 19, 20 actuated in this way is actuated so as to be fully closed, wherein said pressure regulating valve discharges no fuel into the fuel reservoir 7. The high pressure is thus regulated only by means of one pressure regulating valve 19, 20 until the dynamic rail pressure p_{dyn} reaches the second pressure threshold value p_{G2}.

A fourth switching element 44 is provided which determines the value of the factor f_{DRV} already mentioned above. Said fourth switching element 44 is likewise controlled in a manner dependent on the third logic signal SIG2, and assumes its lower switching position illustrated in FIG. 2 if the third logic signal SIG2 has the value “false”. In this case, the output variable of the characteristic curve 43 is multiplied by the factor 1. Correspondingly, the limited setpoint volume flow V_{R} resulting from the limitation element 45 is divided by the factor 1.

If the dynamic rail pressure p_{dyn} rises and reaches or overshoots the second pressure threshold value p_{G2}, the third logic signal SIG2 assumes the value “true”. This has the effect that the third switching element 47 and the fourth switching element 44 switch into their upper switching position in FIG. 2. Considering firstly the third switching element 47, it is evident that, as a result, in the specific exemplary embodiment illustrated here, the second pressure regulating valve setpoint current I_{S,2} is now identical to the first pressure regulating valve setpoint current I_{S}, such that both pressure regulating valves 19, 20 are acted on with the same setpoint current as a result. This in turn assumes that the two pressure regulating valves 19, 20 are of identical form, which corresponds to a preferred embodiment. It is however self-evidently possible for said pressure regulating valves to be acted on with separate setpoint currents, resulting in particular from separate characteristic maps, if the pressure regulating valves 19, 20 differ.

Two identical pressure regulating valves 19, 20 can discharge a doubled fuel quantity in relation to a single pressure regulating valve 19, 20. For this reason, if one now considers the fourth switching element 44, the factor f_{DRV} now assumes the value 2, whereby the maximum volume flow Vₘₐₓ resulting from the characteristic curve 43 is doubled. By contrast, the limited volume flow V_{R} resulting from the limitation element 45 is divided by the factor f_{DRV} and thus in this case by two, because ultimately the resultant pressure regulating valve setpoint volume flow V_{S} corresponds in each case to one pressure regulating valve 19, 20 and serves in each case for the actuation of one pressure regulating valve 19, 20. This approach, too, is adapted to the preferred embodiment in which the two pressure regulating valves 19, 20 that are used are of identical form. By contrast, if said pressure regulating valves are of different form, it is preferable for different characteristic curves 43, different second high-pressure regulating loops 39, and different pressure regulating valve characteristic maps 33, 49 to be used for the actuation of the various pressure regulating valves. By contrast, if more than two pressure regulating valves of identical form are provided, these may be actuated entirely analogously to the illustration in FIG. 2 by means of a multiplication of the actuating elements illustrated there for each pressure regulating valve 19, 20, wherein the number of pressure regulating valves used can be used as factor f_{DRV} in the upper switching position of the fourth switching element 44.

The second pressure regulating valve setpoint current I_{S,2} is the input variable of a second current regulator 51, which is otherwise preferably of exactly the same design as the first current regulator 35. The actuation mechanism for generating the second actuation signal PWMDRV2 otherwise corresponds to that for generating the first actuation signal PWMDRV1, wherein here, a fifth switching element 53 is also provided for the switching between the normal function and the standstill function, and wherein, for the filtering of a second, measured current variable I_{R,2}, a second current filter 55 is provided which has, as output variable, a second actual current I_{I,2} which is fed to the second current regulator 51. The regulator parameters of the second current regulator 51 are preferably set in the same way as the corresponding parameters of the first current regulator 35.

On the basis of the second switching element 29 and the fifth switching element 53, it can also be seen that the activation duration of the actuation signals PWMDRV1, PWMDRV2 is identical to 0% in the standstill function. By contrast, in the normal function, the respective actuation signal PWMDRV1, PWMDRV2 is generated by the actuation mechanism assigned thereto, as has already been discussed above.

The two actuation signals PWMDRV1, PWMDRV2 are fed to a switchover logic 57 which will be discussed in more detail below in conjunction with FIGS. 5 and 6, wherein the switchover logic 57 ensures that the pressure regulating valves 19, 20 are actuated with the actuation signals PWMDRV1, PWMDRV2 alternately. Likewise, the measured current variables I_{R}, I_{R,2} are also taken from the switchover logic 57, wherein the latter ensures that said current variables are always measured at the respective pressure regulating valves 19, 20 correctly assigned to the actuation signals PWMDRV1, PWMDRV2, in order to ensure defined regulation of each of the pressure regulating valves 19, 20 by means of the current regulators 35, 51.

FIG. 3 shows the conditions under which the first logic signal SIG1 and the third logic signal SIG2 in each case assume the values “true” and “false”.

This will be discussed below firstly on the basis of FIG. 3a) for the first logic signal SIG1. For as long as the dynamic rail pressure p_{dyn} does not reach or overshoot a first pressure threshold value p_{G1}, the output of a first comparator element 59 has the value “false”. Upon starting of the internal combustion engine 1, the value of the first logic signal SIG1 is initialized with “false”. In this way, the output of a first OR element 61 is also “false” for as long as the output of the first comparator element 59 has the value “false”. The output of the first OR element 61 is supplied to an input of a first AND element 63, to the other input of which the negative, indicated by a horizontal dash, of a variable MS is supplied, wherein the variable MS has the value “true” if the internal combustion engine 1 is at a standstill, and wherein it has the value “false” when the internal combustion engine 1 is running. Accordingly, during the operation of the internal combustion engine 1, the value of the negative of the variable MS is “true”. Altogether, it is now the case that the output of the AND element 63 and thus the value of the first logic signal SIG1 is “false” for as long as the dynamic rail pressure p_{dyn} does not reach or overshoot the first pressure threshold value p_{G1}. If the dynamic rail pressure p_{dyn} reaches or overshoots the first pressure threshold value p_{G1}, the output of the first comparator element 59 changes from “false” to “true”. Thus, the output of the first OR element 61 also changes from “false” to “true”. When the internal combustion engine 1 is running, the output of the first AND element 63 also changes from “false” to “true”, such that the value of the first logic signal SIG1 becomes “true”. Said value is supplied to the first OR element 61 again, which however does not change the fact that the output thereof remains “true”. Even a drop of the dynamic rail pressure p_{dyn} to below the first pressure threshold value p_{G1} can no longer change the logical value of the first logic signal SIG1. Said value rather remains “true” until the variable MS and thus also the negative thereof changes its logical value, specifically when the internal combustion engine 1 is no longer running. The following is thus the case: the normal operating mode is realized for as long as the dynamic rail pressure p_{dyn} lies below the first pressure threshold value p_{G1}. In this case, the setpoint volume flow V_{S} is identical to the calculated setpoint volume flow V_{S,ber}. If the dynamic rail pressure p_{dyn} reaches or overshoots the first pressure threshold value p_{G1}, the first logic signal SIG1 assumes the value “true”, and the first switching element 27 assumes its upper switching position. Therefore, in this case, the setpoint volume flow V_{S} is identical to the limited volume flow V_{R} of the second high-pressure regulating loop 39—aside from the factor f_{DRV}. This means that, in the normal operating mode, a high-pressure disturbance variable is generated by means of one of the pressure regulating valves 19, 20, wherein, in the first operation type of the protective operating mode, whenever the dynamic rail pressure p_{dyn} reaches the first pressure threshold value p_{G1}, the high pressure is subsequently regulated by the pressure regulating valve pressure regulator 41 until it is identified that the internal combustion engine 1 is at a standstill. In the first operation type of the protective operating mode, at least one of the pressure regulating valves 19, 20 performs the regulation of the high pressure by means of the second high-pressure regulating loop 39.

FIG. 3b) illustrates the logic for the switching of the third logic signal SIG2. Here, it is evident that this logic corresponds entirely to the logic for the switching of the first logic signal SIG1, it merely being the case that the second pressure threshold value p_{G2} rather than the first pressure threshold value p_{G1} is used as input variable. The corresponding logic switching components are in this case provided with reference designations with an apostrophe suffix in relation to FIG. 3a). Owing to the entirely identical functioning, reference is made to the explanations relating to FIG. 3a). Analogously to the first logic signal SIG1, the following is the case for the second logic signal SIG2: said second logic signal is, initialized with the value “false” upon the commencement of operation of the internal combustion engine 1, wherein said second logic signal changes its logical value to “true” if the dynamic rail pressure p_{dyn} reaches or overshoots the second pressure threshold value p_{G2.} The logical value of the third logic signal SIG2 thereupon remains “true” until it is identified that the internal combustion engine 1 is at a standstill.

With reference to FIG. 2, it is evident that the second operation type of the protective operating mode is activated if the third logic signal SIG2 changes its logical value from “false” to “true”, wherein, in this case, the hitherto inactive pressure regulating valve 20, 19 is activated, such that the high pressure is regulated by both pressure regulating valves 19, 20.

Returning to FIG. 2, the third operation type of the protective operating mode will also be discussed below: a switch is made to said third operation type if the second logic signal Z assumes the value 1. In this case, the second switching element 29 and also the fifth switching element 53 are placed into their upper switching position illustrated in FIG. 2, wherein, in this way, the standstill function for both pressure regulating valves 19, 20 is set. In said standstill function, the pressure regulating valves 19, 20 are no longer actuated, that is to say the actuation signals PWMDRV1, PWMDRV2 are set to zero. Since pressure regulating valves 19, 20 which are open when deenergized, at least under the action of inlet pressure, are preferably used, said pressure regulating valves now constantly discharge a maximum fuel volume flow from the high-pressure accumulator 13 into the fuel reservoir 7.

By contrast, if the second logic signal Z has the value 2, it is the case, as already discussed, that the normal function for the pressure regulating valves 19, 20 is set, and said pressure regulating valves are actuated with their respective setpoint currents I_{S}, I_{S,2} and the actuation signals PWMDRV1, PWMDRV2 calculated therefrom.

FIG. 4 schematically shows a state change diagram for the pressure regulating valves 19, 20 from the normal function into the standstill function and vice versa. Here, the pressure regulating valves 19, 20 are preferably designed so as to be closed when unpressurized and deenergized, wherein said pressure regulating valves are furthermore preferably designed so as to be closed when a pressure up to an opening pressure value prevails on the inlet side, wherein said pressure regulating valves open if the pressure prevailing on the inlet side reaches or overshoots the opening pressure value in the deenergized state. Said pressure regulating valves are then open when deenergized under the action of inlet pressure, and can be actuated toward the closed state by energization. The opening pressure value may for example be 850 bar.

In FIG. 4, a first circle K1 symbolizes the standstill function, wherein, at the top right, a second circle K2 symbolizes the normal function. A first arrow P1 represents a transition between the standstill function and the normal function, wherein a second arrow P2 illustrates a transition between the normal function and the standstill function. A third arrow P3 indicates an initialization of the internal combustion engine 1 after starting, wherein the pressure regulating valves 19, 20 are firstly initialized in the standstill function. Only when it is identified that the internal combustion engine 1 is running and, at the same time, the actual high pressure p_{I} overshoots a predetermined starting value p_{St} is the normal function set for the pressure regulating valves 19, 20—along the arrow P1—and the standstill function reset, in particular by virtue of the second logic signal Z changing its value from 1 to 2. The normal function is reset, and the standstill function set along the arrow P2, if the dynamic rail pressure p_{dyn} overshoots the third pressure threshold value p_{G3}, or if a defect of a high-pressure sensor—illustrated in this case by a logic variable HDSD—is identified or if it is identified that the internal combustion engine 1 is at a standstill. In the standstill function, in which the second logic signal Z again assumes the value 1, the pressure regulating valves 19, 20 are not actuated, wherein, in the normal function—as already discussed in conjunction with FIG. 2—said pressure regulating valves are actuated by means of the setpoint currents I_{S}, I_{S,2} respectively assigned thereto.

The following functionality is now realized: upon starting of the internal combustion engine 1, it is initially the case that high pressure does not prevail in the high-pressure accumulator 13, and the pressure regulating valves 19, 20 are arranged in their standstill function, such that they are unpressurized and deenergized, that is to say closed. During the running-up of the internal combustion engine 1, it is thus possible for a high pressure to be rapidly built up in the high-pressure accumulator, which high pressure at some point exceeds the starting value p_{St}. Said starting value is preferably lower than the opening pressure value of the pressure regulating valves 19, 20, such that, for said pressure regulating valves, the normal function is firstly set before said pressure regulating valves open. In this way, it is advantageously ensured that the pressure regulating valves 19, 20 are actuated every time they first open. Since said pressure regulating valves are closed when unpressurized, they remain closed even when actuated until the actual high pressure p_{I} also overshoots the opening pressure value, wherein said pressure regulating valves then open and are actuated in the normal function, specifically either in the normal operating mode or in the first operation type of the protective operating mode.

However, if one of the above-described situations arises, it is in turn the case that the standstill function for the pressure regulating valves 19, 20 is set.

This is the case in particular if the dynamic rail pressure p_{dyn} overshoots the third pressure threshold value p_{G3}, wherein said third pressure threshold value is preferably selected to be higher than the first pressure threshold value p_{G1} and the second pressure threshold value p_{G2}, and has in particular a value at which, in the case of a conventional embodiment of the injection system, a mechanical pressure relief valve would open. Since the pressure regulating valves 19, 20 are open under the action of pressure and when deenergized, said pressure regulating valves in this case open fully in the standstill function and thus safely and reliably ensure the function of a pressure relief valve.

The transition from the normal function to the standstill function also takes place if a defect in the high-pressure sensor 23 is detected. If a defect is present here, it is no longer possible for the high pressure in the high-pressure accumulator 13 to be regulated. In order that the internal combustion engine 1 can nevertheless still be operated safely, the transition from the normal function to the standstill function is effected for the pressure regulating valves 19, 20, such that said pressure regulating valves open and thus prevent an inadmissible rise of the high pressure.

Furthermore, the transition from the normal function into the standstill function is performed in a situation in which it is detected that the internal combustion engine 1 is at a standstill. This corresponds to a resetting of the pressure regulating valves 19, 20, such that, upon a restart of the internal combustion engine 1, the cycle described here can begin again from the start.

If, for the pressure regulating valves 19, 20, under the action of pressure in the high-pressure accumulator 13, the standstill function is set, said pressure regulating valves are opened to the maximum extent and discharge a maximum volume flow from the high-pressure accumulator 13 into the fuel reservoir 7. This corresponds to a protective function for the internal combustion engine 1 and the injection system 3, wherein said protective function can in particular replace the absence of a mechanical pressure relief valve.

It is important here that the pressure regulating valves 19, 20 have only two functional states, specifically the standstill function and the normal function, wherein said two functional states are entirely sufficient to replicate the entire relevant functionality of the pressure regulating valves 19, 20 including the protective function for replacing a mechanical pressure relief valve.

It is evident that, even after an overshooting of the second pressure threshold value p_{G2}, stable regulation of the high pressure by means of the pressure regulating valves remains possible, because the delivery capacity of the high-pressure pump 11 is dependent on engine speed. It is thus possible for engine operating values, in particular emissions values, to still be adhered to in this case. Only in the relatively high engine speed range must an overshooting of the third pressure threshold value p_{G3} be expected. In this case, the pressure regulating valves 19, 20 open fully, and an impairment of the engine operating values, in particular the emissions, must be expected. At least stable operation of the engine however then remains ensured.

Even in the event of a failure of the high-pressure sensor 23, stable engine operation remains possible, even if an impairment of the engine operating values, in particular the emissions values, possibly occurs in this case.

By virtue of the fact that the second pressure threshold value p_{G2} is higher than the first pressure threshold value p_{G1}, a situation is avoided in which the two pressure regulating valves 19, 20 are simultaneously transferred from the closed state into an open state. In this way, large pressure gradients, which could have a damaging effect on the injection system 3, are avoided.

As already indicated, the pressure regulating valves 19, 20 are acted on alternately with the actuation signals PWMDRV1 and PWMDRV2. This means that one of the two pressure regulating valves 19, 20 is acted on with the first actuation signal PWMDRV1 during a predetermined time period, for example 5000 operating hours. At the same time, the other pressure regulating valve 20, 19 is acted on with the second actuation signal PWMDRV2. After the predetermined time period has elapsed, it is conversely the case that said one pressure regulating valve 19, 20 is acted on with the second actuation signal PWMDRV2 and the other pressure regulating valve 20, 19 is acted on with the first actuation signal PWMDRV1, in turn for the predetermined time period. This will now be discussed in more detail in conjunction with FIGS. 5 and 6.

FIG. 5 shows a schematic illustration of a logic for alternating actuation of the pressure regulating valves 19, 20 on the basis of various diagrams. Here, a first diagram 1) shows a time counter Z_{DRV} plotted versus the time t. Curved brackets are used to illustrate in each case one predetermined time period t_{DRV}. The time counter Z_{DRV} has its maximum value, for example 5000 operating hours, at a first time point t₁, after the predetermined time period t_{DRV} has elapsed.

The second, middle diagram 2) shows the logic variable MS as a function of the time t, wherein said logic variable assumes the value 0 when the internal combustion engine 1 is running and the value 1 when the internal combustion engine 1 is at a standstill. Up to a second time point t₂, the variable MS assumes the value 0, that is to say the internal combustion engine 1 is running. At the second time point t₂, said variable assumes the value 1, that is to say it is identified that the internal combustion engine 1 is at a standstill.

On the basis of the first, upper diagram, it is evident that the time counter Z_{DRV} is now reset to 0. Said time counter subsequently runs up to its maximum value again, which is then reached again at a third time point t₃. Between the first time point ti and the second time point t₂, no change in the time counter Z_{DRV} occurs, because this has reached its maximum value, but it has not yet been identified that the internal combustion engine 1 is at a standstill. At the third time point t₃, the time counter Z_{DRV} is reset to the value 0 again because the second diagram indicates that the engine is at a standstill. Subsequently, the time counter Z_{DRV} is incremented again until it finally reaches its maximum value again at a fourth time point t₄. Since the second diagram indicates that the engine is at a standstill at a fifth time point t₅, the time counter is, corresponding to the first diagram, reset to the value 0 at the fifth time point t₅. Thereafter, the counter runs up to its maximum value again, which it reaches again at a sixth time point t₆. The third, lower diagram 3) illustrates a fourth logic signal SIG4 plotted versus the time t. Said fourth logic signal SIG4 indicates when a change in the assignment of the actuation signals PWMDRV1, PWMDRV2 to the corresponding pressure regulating valves 19, 20 should be performed. Said fourth logic signal SIG4 has the value 0 at the time point 0. A change in the value of the fourth logic signal SIG4 occurs whenever the time counter Z_{DRV} has reached its maximum value and, at the same time, the logic signal MS indicates that the internal combustion engine 1 is at a standstill. This means that the signal SIG4 changes from the value 0 to the value 1 at the second time point t₂, from the value 1 to the value 0 at the third time point t₃, and from the value 0 to the value 1 again at the fifth time point t₅. Altogether, therefore, a change in the value of the fourth logic signal SIG4 and thus in the assignment of the actuation signals PWMDRV1, PWMDRV2 to the pressure regulating valves 19, 20 occur at said time points.

FIG. 6 shows a function of the switching logic 57 in a schematic illustration. Said switching logic has a sixth switching element 65 and a seventh switching element 67, which change their switching position in a manner dependent on the fourth logic signal SIG4. If the fourth logic signal SIG4 assumes the value 0, both switching elements 65, 67 are in their upper switching position illustrated in FIG. 6. Thus, the first actuation signal PWMDRV1 is assigned to the first pressure regulating valve 19, wherein, at the same time, the second actuation signal PWMDRV2 is assigned to the second pressure regulating valve 20. At the same time—possibly by means of additional physical switching elements, but discussed here together with the actuation signals for the sake of a simpler illustration—the first measured current variable I_{R} is measured at the first pressure regulating valve 19, wherein the second measured current variable I_{R,2} is measured at the second pressure regulating valve 20.

If the fourth logic signal SIG4 assumes the value 1, the switching elements 65, 67 switch to their lower switching position illustrated in FIG. 6. Thus, the first actuation signal PWMDRV1 is now assigned to the second pressure regulating valve 20, wherein the second actuation signal PWMDRV2 is assigned to the first pressure regulating valve 19. At the same time, the first measured current variable I_{R} is measured at the second pressure regulating valve 20, wherein the second measured current variable I_{R,2} is measured at the first pressure regulating valve 19.

The switching logic 57 thus has the effect, in a manner dependent on the fourth logic signal SIG4, that the pressure regulating valves 19, 20 are actuated with the different actuation signals PWMDRV1, PWMDRV2 alternately, wherein it is at the same time ensured that the current regulators 35, 51 provided for this purpose are supplied the correct measured current variables I_{R}, I_{R,2} in each case.

FIG. 7 is a schematic illustration of the pressure regulating valve pressure regulator 41, which in this case is in the form of a PI(DT₁) pressure regulator. Here, it is evident that the output variable V_{U} of the pressure regulating valve pressure regulator 41 is composed of three added-together regulator components, specifically a proportional component A_{P}, an integral component A_{I} and a differential component A_{DTI}. Said three components are added together at a summing junction 69 to form the unlimited volume flow V_{U}. Here, the proportional component A_{P} represents the product of the regulating deviation eₚ, multiplied at a multiplication junction 71 by the value −1, with the proportional coefficient kp_{DRV}. The integrating component A_{I} results from the sum of two summands. The first summand is in this case the present integral component A_{I} delayed by a sampling step Tₐ. The second summand is the product of a gain factor r2_{DRV} and the sum of the present regulating deviation e_{P} and of said regulating deviation delayed by one sampling step—again multiplied at the multiplication junction 71 by the factor −1. The sum of the two summands is in this case limited upwardly to the maximum volume flow Vₘₐₓ in a limitation element 73. The gain factor r2_{DRV} is calculated in accordance with the following formula, in which tn_{DRV} is a reset time:

$$r {2}_{DRV} = \frac{64 {kp}_{DRV} {T}_{a}}{{tn}_{DRV}} . \qquad ( 2 )$$

The integrating component A_{I} is dependent on whether the dynamic rail pressure p_{dyn} has reached the first pressure threshold value p_{G1} for the first time after the starting of the internal combustion engine 1. If this is the case, the first logic signal SIG1 assumes the value “true”, and an eighth switching element 75 illustrated in FIG. 7 switches into its lower switching position. In said switching position, the integrating component A_{I} is identical to the output signal of the limitation element 73, that is to say the integrating component A_{I} is limited to the maximum volume flow Vₘₐₓ. If it is identified that the internal combustion engine 1 is at a standstill, it is the case—as already discussed in conjunction with FIG. 3—that the first logic signal SIG1 assumes the value “false”, and the eighth switching element 75 switches into its upper switching position. The integrating component A_{I} is in this case set to the calculated volume flow V_{S,ber}. Thus, the calculated setpoint volume flow V_{S,ber} constitutes the initialization value of the integrating component A_{I} for the situation in which the pressure regulating valve pressure regulator 41 is activated when the dynamic rail pressure p_{dyn} overshoots the first pressure threshold value p_{G1}.

The calculation of the differential component A_{DTI} is illustrated in the lower part of FIG. 7. Said component is formed as the sum of two products. The first product results from a multiplication of the factor r4_{DRV} with the differential fraction A_{DTI} delayed by one sampling step. The second product is formed from the multiplication of the factor r3_{DRV} with the difference between the regulating deviation eₚ multiplied by the factor −1 and the corresponding regulating deviation eₚ delayed by one sampling step and multiplied by the factor −1.

Here, the factor r3_{DRV} is calculated in accordance with the following equation, in which tv_{DRV} is a lead time and t1_{DRV} is a lag time:

$$r {3}_{DRV} = \frac{2 {kp}_{DRV} {tv}_{DRV}}{2 t {1}_{DRV} + {T}_{a}} . \qquad ( 3 )$$

The factor r4_{DRV} is calculated in accordance with the following equation:

$$r {4}_{DRV} = \frac{2 t {1}_{DRV} - {T}_{a}}{2 t {1}_{DRV} + {T}_{a}} . \qquad ( 4 )$$

It is thus evident that the gain factors r2_{DRV} and r3_{DRV} are dependent on the proportional coefficient kp_{DRV}. The gain factor r2_{DRV} is additionally dependent on the reset time tn_{DRV}, the gain factor r3_{DRV} is additionally dependent on the lead time tv_{DRV} and on the lag time t1_{DRV}. The gain factor r4_{DRV} is likewise dependent on the lag time t1_{DRV}.

FIG. 8 is a schematic illustration of a logic arrangement for the calculation of the value of a fifth logic signal SIG5 which is used to ensure that, in the first and in the second operation types of the protective operating mode, the suction throttle 9 is actuated for permanently open operation. This approach will be discussed in more detail in conjunction with FIG. 9. The value of the fifth logic signal SIG5 results from a third AND element 77, into the first input of which it is again the case that the negative of the variable MS is input, wherein the result of a prior calculation that will be discussed in more detail below is input into the second input. The fifth logic signal SIG5 is, upon the starting of the internal combustion engine 1, firstly initialized with the value “false”. Into a first input of a third OR element 79 there is input the result of a third comparator element 81, in which it is checked whether the dynamic rail pressure p_{dyn} is greater than or equal to the third pressure threshold value p_{G3}. Into the second input of the third OR element 79 there is input the result of a comparison element 83 which checks whether the value of the logic variable HDSD, which indicates a sensor defect of the high-pressure sensor 23, is equal to 1, wherein, in this case, a sensor defect is present, and wherein no sensor defect is present if the value of the variable HDSD is equal to 0. It is thus evident that the output of the third OR element 79 assumes the value “true” if at least one of the outputs of the third comparator element 81 or of the comparison element 83 assumes the value “true”. Thus, in order for the output of the third OR element 79 to assume the value “true”, at least one of the following conditions must be met: the dynamic rail pressure p_{dyn} must have reached or overshot the third pressure threshold value p_{G3}, and/or a sensor defect of the high-pressure sensor 23 must have been detected, such that the variable HDSD assumes the value 1. If neither of said conditions is met, the output of the third OR element 79 has the value “false”.

The output of the third OR element 79 is input into a first input of a fourth OR element 85, into the second input of which the value of the fifth logic signal SIG5 is input. Since said fifth logic signal is originally initialized with the value “false”, the output of the fourth OR element 85 has the value “false” until the output of the third OR element 79 assumes the value “true”. If this is the case, the output of the fourth OR element 85 also changes to the value “true”. In this case, the value of the third OR element 77 also changes to “true” if the internal combustion engine 1 is running, such that the value of the fifth logic signal SIG5 also changes to “true”. It is evident from FIG. 8 that the value of the fifth logic signal SIG5 remains “true” until it is identified that the internal combustion engine 1 is at a standstill, wherein, in this case, the variable MS assumes the value “true”, and thus the negative thereof assumes the value “false”.

If it is sought for the suction throttle 9 to be permanently open also in the second and/or in the first operation type of the protective operating mode, in particular in order to prevent duplicate regulation of the high pressure by means of the suction throttle 9 and the pressure regulating valves 19, 20, this can be achieved by virtue of the second pressure threshold value p_{G2} or the first pressure threshold value p_{G1} instead of the third pressure threshold value p_{G3} being used in the third comparator element 81 and being compared with the dynamic rail pressure p_{dyn}.

FIG. 9 is a schematic illustration of the first high-pressure regulating loop 25 including a ninth switching element 87 for realizing the permanently open operation of the suction throttle 9 in the first, second and/or third operation types of the protective operating mode, wherein the fifth logic signal SIG5, the calculation of which has been described in conjunction with FIG. 8, is input into the ninth switching element 87 for the actuation thereof. It is possible for the ninth switching element 87 to be in the form of a software switch, that is to say in the form of a purely virtual switch. Alternatively, it is self-evidently also possible for the ninth switching element 87 to be in the form of a physical switch, for example a relay.

As has already been discussed, an input variable of the first high-pressure regulating loop 25 is the setpoint high pressure p_{S} which in this case, for the calculation of the regulating deviation eₚ, is compared with the actual high pressure p_{I}. Said regulating deviation eₚ is an input variable of a high-pressure regulator 89, which is preferably implemented as a PI(DT₁) algorithm. A further input variable of the high-pressure regulator 89 is preferably a proportional coefficient kp_{SD}. An output variable of the high-pressure regulator 89 is a fuel volume flow V_{SD} for the suction throttle 9, to which, at a summing junction 91, a fuel setpoint consumption V_{Q} is added. Said fuel setpoint consumption V_{Q} is calculated in a calculation element 93 in a manner dependent on the engine speed n_{I} and the setpoint injection quantity Q_{S}, and constitutes a disturbance variable of the first high-pressure regulating loop 25. A sum of the output variable V_{SD} of the high-pressure regulator 89 and of the disturbance variable V_{Q} yields an unlimited fuel setpoint volume flow V_{U,SD}. This is, in a limitation element 95, limited in a manner dependent on the engine speed n_{I} to a maximum volume flow V_{max,SD} for the suction throttle 9. An output of the limitation element 95 is a limited fuel setpoint volume flow V_{S,SD} for the suction throttle 9, this being input as an input variable into a pump characteristic curve 97. The latter converts the limited fuel setpoint volume flow V_{S,SD} into a characteristic curve suction throttle current I_{KL,SD}.

If the ninth switching element 87 is in the upper switching state illustrated in FIG. 9, which is the case if the fifth logic signal SIG5 has the value “false”, a suction throttle setpoint current I_{S,SD} is set equal to the characteristic curve suction throttle current I_{KL,SD}. Said suction throttle setpoint current I_{S,SD} constitutes the input variable of a suction throttle current regulator 99 which has the task of regulating the suction throttle current through the suction throttle 9. A further input variable of the suction throttle current regulator 99 is, inter alia, an actual suction throttle current I_{I,SD}. An output variable of the suction throttle current regulator 99 is a suction throttle setpoint voltage U_{S,SD} which is finally, in a calculation element 101, converted in a manner known per se into an activation duration of a pulse-width-modulated signal PWMSD for the suction throttle 9. The suction throttle 9 is actuated using said signal, wherein the signal thus acts overall on a regulating path 103 which has in particular the suction throttle 9, the high-pressure pump 11 and the high-pressure accumulator 13. The suction throttle current is measured, wherein the result is an unprocessed measurement value I_{R,SD} which is filtered in a current filter 105. The current filter 105 is preferably in the form of a PT_{I} filter. An output variable of said filter is the actual suction throttle current I_{I,SD}, which in turn is supplied to the suction throttle current regulator 99.

The regulating variable of the first high-pressure regulating loop 25 is the high pressure in the high-pressure accumulator 13. Unprocessed values of said high pressure p are measured by means of the high-pressure sensor 23 and filtered by means of a first high-pressure filter element 107, which, as output variable, has the actual high pressure p_{I}. Furthermore, the unprocessed values of the high pressure p are filtered by means of a second high-pressure filter element 109, the output variable of which is the dynamic rail pressure p_{dyn}. Both high-pressure filter elements are preferably implemented by means of a PT_{I} algorithm, wherein a time constant of the first high-pressure filter element 107 is greater than a time constant of the second high-pressure filter element 109. In particular, the second high-pressure filter element 109 is configured so as to be a faster filter than the first high-pressure filter element 107. The time constant of the second high-pressure filter element 109 may also be identical to the value zero, such that then, the dynamic rail pressure p_{dyn} corresponds to, or is identical to, the measured unprocessed values of the high pressure p. Thus, with the dynamic rail pressure p_{dyn}, a highly dynamic value for the high pressure is available, which is in particular required whenever a fast reaction to certain occurring events is necessary.

Output variables of the first high-pressure regulating loop 25 are thus, aside from the unfiltered high pressure p, the filtered high-pressure values p_{I}, p_{dyn}.

If the fifth logic signal SIG5 assumes the value “true”, the ninth switching element 87 switches into its lower switching position illustrated in FIG. 9. In this case, the suction throttle setpoint current I_{S,SD} is no longer identical to the characteristic curve suction throttle current I_{KL,SD}, but rather is set equal to a suction throttle emergency current I_{N,SD}. The suction throttle emergency current I_{N,SD} preferably has a predetermined constant value, for example 0 A, wherein then, the suction throttle 9, which is preferably open when deenergized, is opened to a maximum extent, or said suction throttle emergency current has a low current value in relation to a maximum closed position of the suction throttle 9, for example 0.5 A, such that the suction throttle 9 is opened not fully but substantially. Here, the suction throttle emergency current I_{N,SD} and the associated opening of the suction throttle 9 reliably prevent the internal combustion engine 1 from coming to a standstill when it is operated in the third operation type of the protective operating mode with pressure regulating valves 19, 20 opened to the maximum extent. Here, the opening of the suction throttle 9 has the effect that, even in a medium to low engine speed range, it is still possible for enough fuel to be delivered into the high-pressure accumulator 13 that operation of the internal combustion engine 1 is possible without stalling. In the first and/or second operation type, it is achieved in this way that twofold regulation of the high pressure both by means of the suction throttle 9 and by means of the pressure regulating valves 19, 20 is prevented.

Altogether, it is evident that, with the aid of the method, the injection system 3 and the internal combustion engine 1, it is possible for stable pressure regulation to be implemented even if the first high-pressure regulating loop 25 can no longer perform the pressure regulation, wherein it is alternatively or additionally possible to omit a mechanical pressure relief valve, because the functionality thereof is performed by the pressure regulating valves 19, 20. It is furthermore evident that the injection system 3 can be readily scaled with regard to a size of an internal combustion engine 1 with which it is used, by virtue of the number of pressure regulating valves 19, 20 being adapted. It is thus possible in particular to use pressure regulating valves 19, 20 which can be produced inexpensively, such as are known for example from automobile series production. If, for example, a cable breakage of a suction throttle plug connector occurs in the lower engine speed range, then in said range, after the first or second pressure threshold value p_{G1}, p_{G2} is reached or overshot, stable regulation of the high pressure remains possible by means of the pressure regulating valves 19, 20, because the delivery capacity of the high-pressure pump is dependent on engine speed. It is possible for predetermined engine operating values, in particular emissions values, to still be adhered to in this case. Only in relatively high engine speed ranges must an overshooting also of the third pressure threshold value p_{G3} be expected. In this case, the pressure regulating valves 19, 20 open fully, and an impairment of the engine operating values, in particular the emissions, must be expected. At least stable operation of the internal combustion engine 1 however then remains ensured. Even in the event of a failure of the high-pressure sensor 23, stable operation of the internal combustion engine 1 is possible, even if an impairment of the operating values possibly occurs in this case.

By virtue of the fact that the pressure regulating valves 19, 20 are not activated simultaneously, a situation is prevented in which the injection system 3 is damaged by excessively large high-pressure gradients. If more than two pressure regulating valves 19, 20 are provided, it is possible for separate pressure threshold values to be defined for an activation of each of said pressure regulating valves 19, 20 or for an activation of groups of said pressure regulating valves 19, 20, which pressure threshold values may in particular be staggered in terms of their magnitude.

The pressure regulating valves 19, 20 are utilized uniformly by way of alternate actuation.

Altogether, the following functionality for the internal combustion engine 1 and the injection system 3 is also evident:

Said internal combustion engine comprises at least two pressure regulating valves 19, 20 but no mechanical pressure relief valve. If the high pressure rises, for example as a result of a cable breakage of a suction throttle plug connector, and if the dynamic rail pressure p_{dyn} in this case reaches the first pressure threshold value p_{G1}, then the second high-pressure regulating loop 39 performs the regulation of the high pressure by actuating one of the pressure regulating valves 19, 20. Here, the other pressure regulating valve 20, 19 is actuated so as to remain closed.

If, while the internal combustion engine 1 is running, despite activation of one pressure regulating valve 19, 20, the dynamic rail pressure p_{dyn} reaches or exceeds the second pressure threshold value p_{G2}, which is preferably higher than the first pressure threshold value p_{G1}, then the further pressure regulating valve 20, 19 is additionally activated in order to regulate the high pressure. It is preferable for both pressure regulating valves 19, 20 to be actuated with the same setpoint current I_{S}, I_{S,2}.

If the dynamic rail pressure p_{dyn} reaches or exceeds the third pressure threshold value p_{G3}, which is preferably higher than the first pressure threshold value p_{G1} and the second pressure threshold value p_{G2}, or if the high-pressure sensor 23 fails, the pressure regulating valves 19, 20 are actuated such that they reliably, permanently and preferably fully open. In all cases, the suction throttle 9 is preferably simultaneously actuated so as to likewise be operated in the fully open state. The pressure regulating valves 19, 20 are actuated alternately at predefinable time intervals. Here, a change may be performed only when the internal combustion engine 1 is at a standstill.

1-10. (canceled)

11. An injection system for an internal combustion engine, comprising:
at least one injector;
a high-pressure accumulator which is fluidically connected at one side to the at least one injector and at another side via a high-pressure pump to a fuel reservoir;
a suction throttle assigned to the high-pressure pump as a pressure setting element; and
at least two pressure regulating valves by which the high-pressure accumulator is fluidically connectable to the fuel reservoir.

12. The injection system according to claim 11, further comprising a control unit operatively connected to the suction throttle and to the at least two pressure regulating valves, wherein the injection system is configured to,
a) in a normal operating mode, regulate a high pressure in the high-pressure accumulator by actuating the suction throttle as the pressure setting element, wherein, at least one first pressure regulating valve of the at least two pressure regulating valves is actuated in order to generate a high-pressure disturbance variable;
b) in a first operation type of a protective operating mode, regulate the high pressure in the high-pressure accumulator by actuating the at least one first pressure regulating valve as pressure setting element; and
c) in a second operation type of the protective operating mode, actuate at least one second pressure regulating valve of the at least two pressure regulating valves, which differs from the at least one first pressure regulating valve, in addition to the at least one first pressure regulating valve as pressure setting element to regulate the high pressure in the high-pressure accumulator.

13. The injection system according to claim 12, wherein the injection system is configured to, in a third operation type of the protective operating mode, permanently open the at least one first pressure regulating valve and the at least one second pressure regulating valve.

14. The injection system according to claim 13, wherein the injection system is configured to
d) switch to the first operation type of the protective operating mode when the high pressure reaches or overshoots a first pressure threshold value or if a defect of the suction throttle is detected, and/or
e) switch to the second operation type of the protective operating mode when the high pressure reaches or overshoots a second pressure threshold value, and/or
f) switch to the third operation type of the protective operating mode when the high pressure reaches or overshoots a third pressure threshold value or if a defect of a high-pressure sensor is detected.

15. The injection system according to claim 12, wherein the injection system is configured to, in at least one operation type of the protective operating mode, actuate the suction throttle so that the suction throttle assumes a permanently open position.

16. The injection system according to claim 11, wherein at least one of the at least two pressure regulating valves is configured to be open when deenergized.

17. The injection system according to claim 12, wherein the injection system is configured to generate a first actuation signal and a second actuation signal and to actuate the at least one first pressure regulating valve and the at least one second pressure regulating valve alternately with the first actuation signal and the second actuation signal.

18. The injection system according to claim 11, wherein the injection system is free from a mechanical pressure relief valve.

19. An internal combustion engine comprising an injection system according to claim 11.

20. The internal combustion engine according to claim 19, wherein the internal combustion engine is a large engine.
